(19) United States
(12) Patent Application Publication
(10) Pub. No.: US 2004/0129040 A1
(43) Pub. Date: Jul. 8, 2004

(54) Device for operating a lock on doors flaps or similar in particular on vehicles

(76) Inventors: Reinhold Mathofer, Wulfrath (DE); Mirko Alexander Rohring, Mettmann (DE); Rudi Kolle, Sindelfingen (DE); Martin Lindmayer, Sulz a. N. (DE); Ralf Lennhoff, Dortmund (DE); Udo Babatz, Freiberg (DE)

Correspondence Address: Friedrich Kueffner, Suite 910, 317 Madison Avenue, New York, NY, 10017, US

(21) Appl. No.: 10/469,465

(22) PCT Filed: Feb. 28, 2002
(86) PCT No.: PCT/EP02/02137

(30) Foreign Application Priority Data
Mar. 1, 2001 (DE) 101 09 824.3
Mar. 1, 2001 (DE) 101 09 825.1

(51) Int. Cl. E05B 13/00

(52) U.S. Cl. 70/208; 70/210

(57) ABSTRACT

In said devices the operation of the handle serves to open the door when the lock is in the unlocked position. The handle operation is achieved by means of an operating lever (30) and the rotation of the lock cylinder (60) is transferred to a carrier (45). According to the invention, the construction may be simplified and rendered flexible, whereby a control member (50) is used, which transmits the movement of the carrier (45) to the operating lever (30) of the handle. The operating lever (30) has an adjustable bearing position (31, 11 or 32, 12), which is determined in relation to the rotational position of the lock cylinder (60) by the control member (50). The transfer ratios (34.1 to 33.1 or 34.2 to 33.2) on the operating lever (30) are thus altered relative to a connector (40) leading to the lock. Although an identical operation of the handle occurs, differing working strokes (36) occur at the connector (40). Said differing working strokes (36) are recognised by the lock which then enables different functions depending thereon.

The invention pertains to a device of the type indicated in the introductory clause of Claim 1. In devices of this type, actuating the handle has the effect of opening the door if the door lock is in the released position. When a key turns the lock cylinder, it is supposed to switch the door lock from the securing position to this released position. When the door lock is in the securing position, the previously mentioned actuation of the handle will not have the effect of opening of the door; the closed door will remain closed. In modern systems with electromechanical keys and their associated locks, the door lock is usually switched between the securing position and the released position by electrical means. Such switchovers can be accomplished, for example, by means of a remote control unit, which is operated as part of a wireless key system. The use of a mechanical key is required only in an emergency, such as when one of the electrical components or the electrical power supply in the vehicle fails.

So that they can be actuated manually, these types of devices therefore have two different actuating means, namely, the handle and the key, which acts on the lock cylinder. In many cases, such as those involving “keyless entry”, the lock cylinder and the key can be combined into a single unit, which makes it unnecessary to insert a key and to pull it back out again.

In the known devices of this type (DE 44 45 320 A1), two separate link chains are required, one between each of the two actuating means and the door lock. The handle acts on an actuating lever, to which a first connection leading to the door lock is connected; when the handle is actuated, this connection releases the engagement between a catch on the door and a stationary locking element on the doorframe. Another link chain is connected to the output of the lock cylinder; this chain moves the door lock into either the previously mentioned securing or released position, depending on how the key is actuated.

Because the known device has two link chains as well as the door lock, it requires twice the amount of space, and the components must be installed in the door so that they occupy certain positions with respect to each other. These positions can vary widely from one type of vehicle to another, for which reason in practice a different device must be developed for each type of vehicle to take into account the paths that the two different connections must take. Manufacturing tolerances alone are sufficient to create installation problems even when the known devices are mounted on vehicles of the same type; tedious corrections must be made to compensate for the discrepancies between the positions of the two connections to the door lock, i.e., the connection between the door lock and the lock cylinder and the connection between the door lock and the actuating lever associated with the handle.

To make this adjustment work easier, it is known that a Bowden cable can be attached to the handle to connect the handle to the door lock. The Bowden cable makes it possible for the door lock to be positioned in the door in a manner that is almost completely independent of the position of the handle. Problems remain, however, in regard to the modifications that must be made to the second chain of connecting links, i.e., the chain that extends between the door lock and the lock cylinder. For this purpose, it is known (EP 0 722 028 B1) that a connecting rod, serving as an input element, with universal joints at its ends, can be installed between the lock cylinder and the door lock, but these measures also limit the freedom with which the device can be positioned with respect to its two actuating means.

In a device of a different type, which does not have a transfer element between the handle and a connection leading to the door lock (DE 196 40 595 A1), it is known that a Bowden cable can be provided between the handle and the door lock, into which a lock cylinder is integrated. A Bowden cable of this type consists, as is known, of a sleeve with a cable inside. In this case, one end of the cable is connected directly, without an intermediate transfer element, to the handle. One end of the sleeve is connected nonrotatably to the lock cylinder, and the other end of the sleeve is kept stationary. When the lock cylinder is rotated, the sleeve is carried along, together with the cable inside it. Because the Bowden cable is laid out in the form of a “U”, the lengths of the two sidepieces of the U change when the lock cylinder rotates. This change in the lengths of the U-sidepieces changes the position of the second end of the cable, as a result of which a lever system connected to it executes pivoting movements and, to some extent, linear displacements. A separate pneumatic or electrical actuating device independent of the Bowden cable is required to reset one of these levers; this actuating device is controlled by the lock cylinder. This device, too, occupies a large amount of space.

The invention is based on the task of developing a reliable device of the type indicated in the introductory clause of Claim 1, which avoids the disadvantages described above. This is accomplished according to the invention by the measures stated in Claim 1, to which the following special meaning attaches:

Although, as said above, the device has basically two actuating means, namely, the manually actuated handle and the key-actuated lock cylinder, the invention requires only a single chain of connecting links. Because, according to the invention, only a single connection is required between the door lock and the device, the installation of the door lock and of the device in the door is simplified and facilitated.

When a Bowden cable is used as the connection, the device can be positioned in the door almost independently of the position of the door lock. The invention makes it possible to develop a device of a standard type, which can be used equally well in many different types of vehicles regardless of how much the relative positions of the actuating means and the door locks differ. Nor is there any need to worry about manufacturing tolerances. Standard models allow for very large production runs, which means that the device according to the invention can be manufactured at very low cost.

The invention has recognized that the installation procedure can be made much simpler, as mentioned above, by having the lock cylinder act by way of a structural unit consisting of the handle and the transfer element on a common link chain for the handle, where different working strokes are produced in the link chain as a function of the rotational position of the lock cylinder. On the basis of these different working strokes, the door lock can tell whether only the handle has been actuated or whether the lock cylinder has been moved from one position to another. In correspondence with these different working strokes, different functions are then initiated in the door lock. In the normal case, when the door lock is in the released position, for example, a short working stroke has the effect of opening the lock. But when the door lock is in the securing position and an emergency situation is present, the lock cylinder can be moved by a key into a different rotational position, which results in the production of a long working stroke in the link chain of the handle. This long stroke opens the door lock immediately or at least opens the door after a second actuation of the handle.

The possibilities differ, depending on whether the output of the lock cylinder acts on the transfer element or on the handle of the structural unit. Each possibility offers its own special advantages.

In a first possibility, which is described in Claim 2, the output of the lock cylinder acts on the transfer element. In this case, the transmission ratio of the transfer element changes as a function of the rotational position of the lock cylinder. The actuating angle around which the handle is turned can remain the same. What does change, however, is the working stroke of the link chain, which changes as a function of the transmission ratio of the transfer element. On the basis of the length of the working stroke, the door lock can recognize clearly whether the control pulse has come from the lock cylinder or from the handle, and it can react accordingly. For example, when an emergency occurs and the door lock is in a securing position, i.e., a position in which an actuation of the handle normally has no effect, a control pulse can be produced and transmitted by using a key to actuate the lock cylinder and by actuating the handle a first time. This pulse moves the door lock into its released position. When the handle is now actuated a second time, that is, turned again by the same amount, the transfer element produces a working stroke, which opens the door by the use of the same link chain.

The other possibility, stated in Claim 3, consists in using the output to change the angle around which the handle pivots. When the lock cylinder is in one of its rotational positions, the handle can pivot around only a small angle, but when the cylinder is in its other position, the handle can pivot around a large angle. This results in different working strokes of the link chain, which executes a short stroke in the former case and a large stroke in the latter case. If the door lock is already in its released position, the lock cylinder will normally allow the handle to make a short pivoting movement, for example, which produces a short working stroke of the chain and opens the door lock as desired. In an emergency, however, such as when the door lock cannot be actuated as desired by the use of a remote-control key, that is, when an emergency situation is present, a mechanical key can be used to actuate the lock cylinder, so that the output element will now allow the handle to be actuated over a large pivot angle. The link chain will now execute a long working stroke, which will have the effect of opening the door.

Various additional measures and advantages of the two variants according to Claims 2 and 3 are presented in the subclaims; these measures and advantages are explained in greater detail in the following description and in the drawings. The drawings illustrate the invention on the basis of several exemplary embodiments:

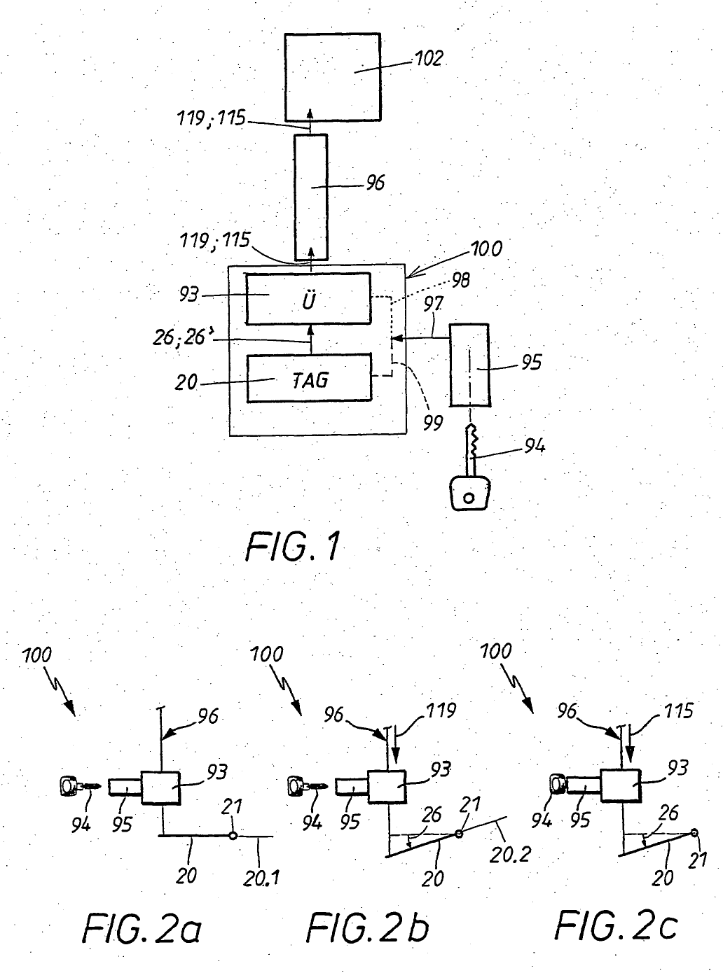

FIG. 1 shows a functional block diagram of the components on the basis of which the two variants of the device according to the invention are presented;

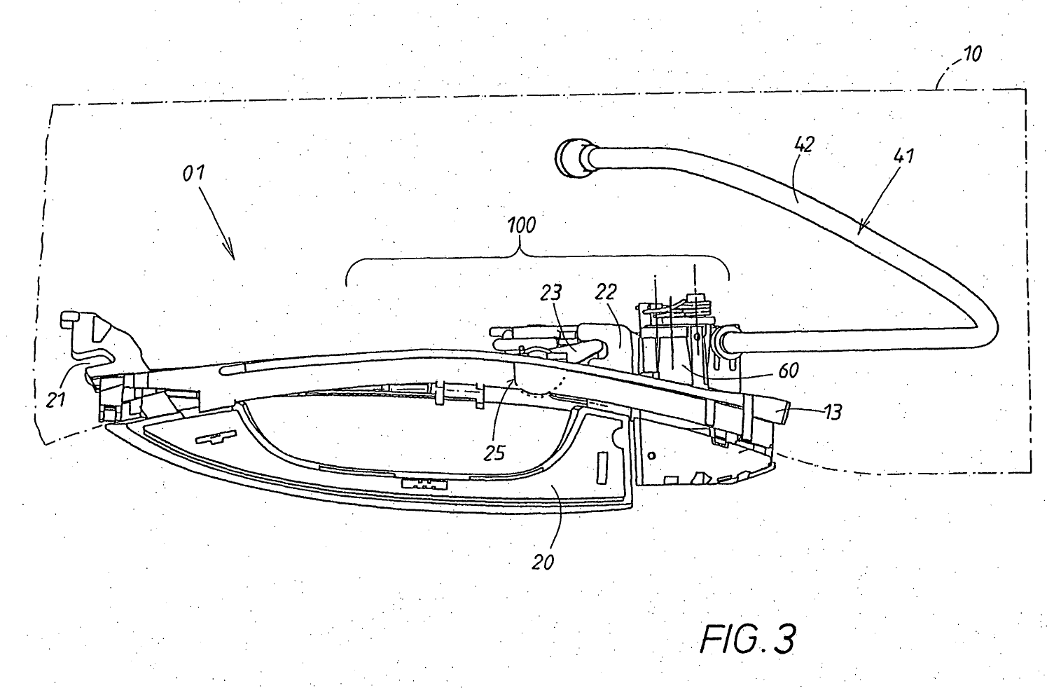

FIGS. 2a-2c show schematic diagrams of three different phases of the first variant of the device;

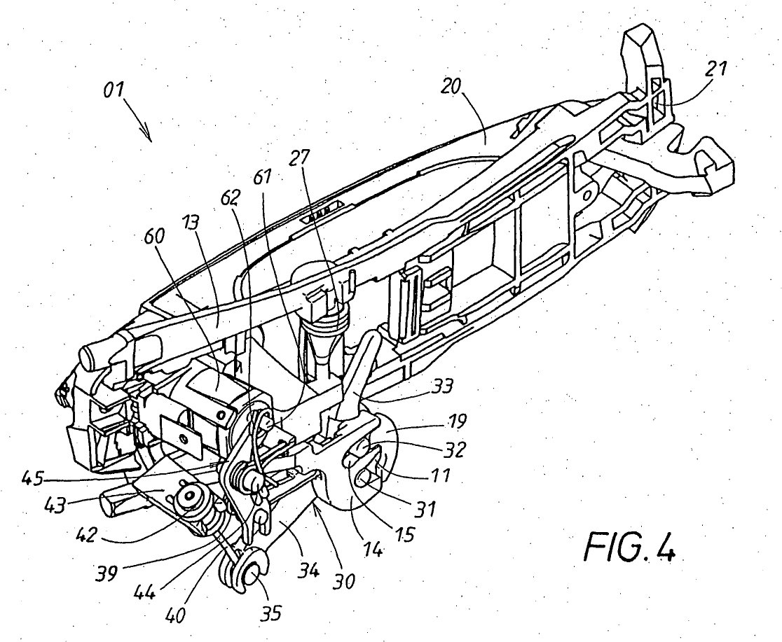

FIG. 3 shows a plan view of a first exemplary embodiment of the first variant of the device according to the invention and, in dash-dot outline, the door in which the device has been installed;

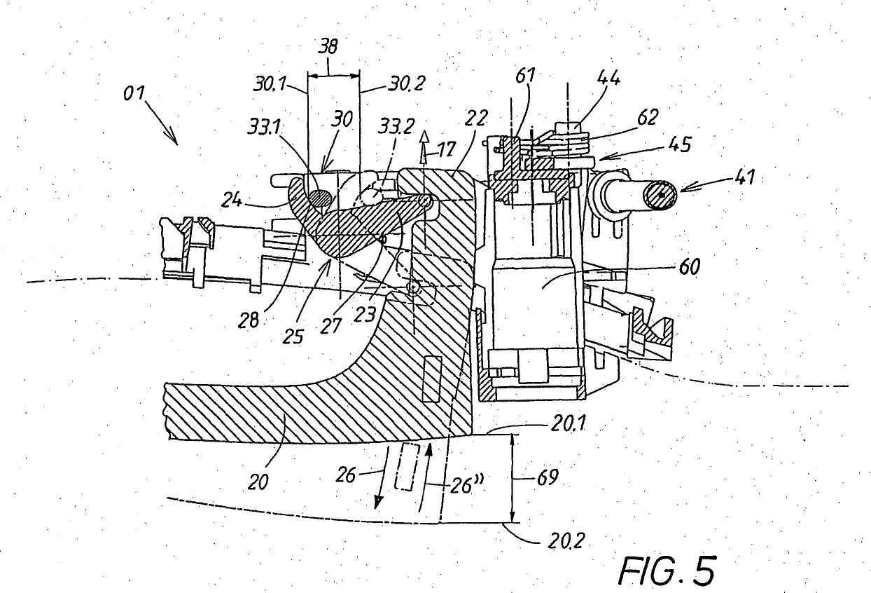

FIG. 4 shows a perspective view of the rear of the device of FIG. 3, the door being omitted;

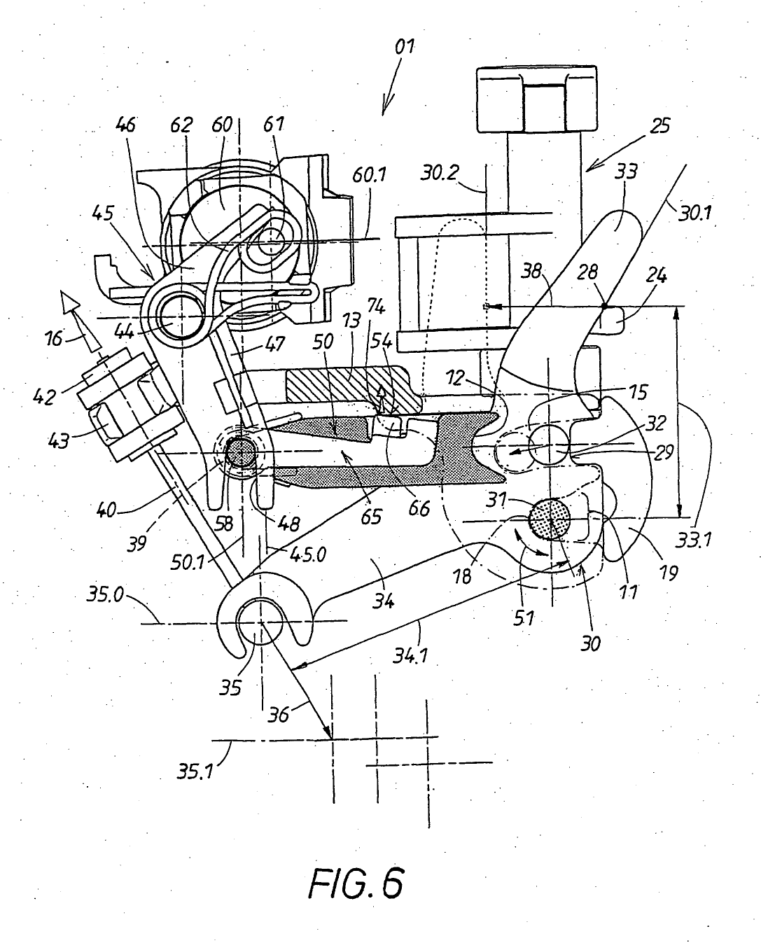

FIG. 5 shows a magnified plan view of a horizontal cross section of a detail of the device shown in FIGS. 3 and 4, where the shaded component is a reversing lever, which is installed between a handle and a transfer lever belonging to the device; also shown, in dash-dot line, are the pulled positions of the handle and of the reversing lever;

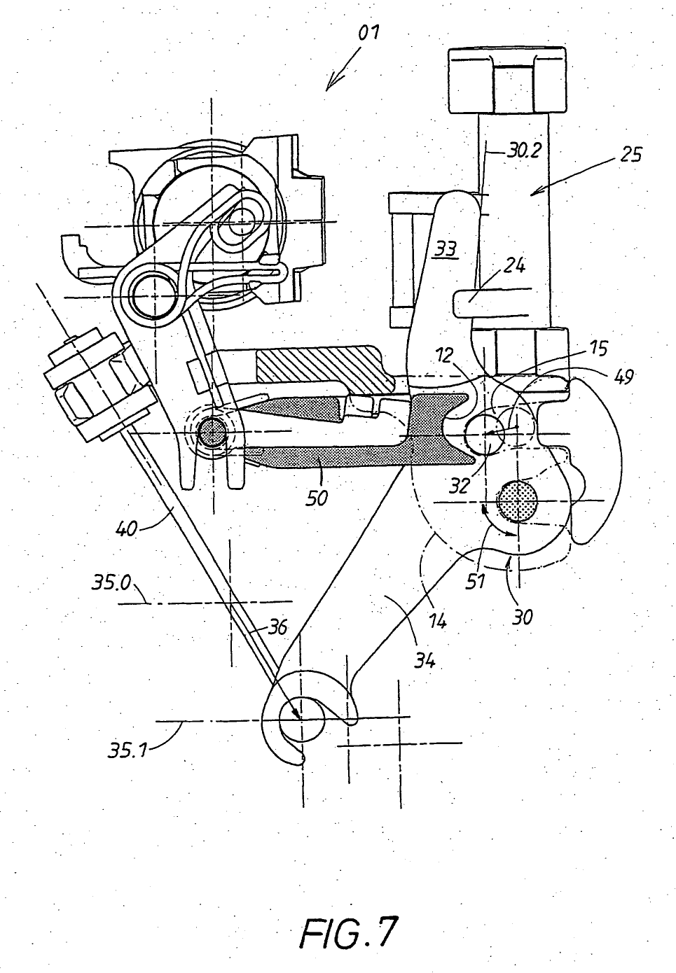

FIG. 6 shows a rear view of the most essential components of the device illustrated in FIGS. 3-5 in a state in which the lock cylinder is in its null position, the handle is in its home position, and the door lock has already been released, where a bracket on which these components are mounted has been partially cut away to show the internal structure of the device, the outline of this omitted bracket being indicated in dash-dot line;

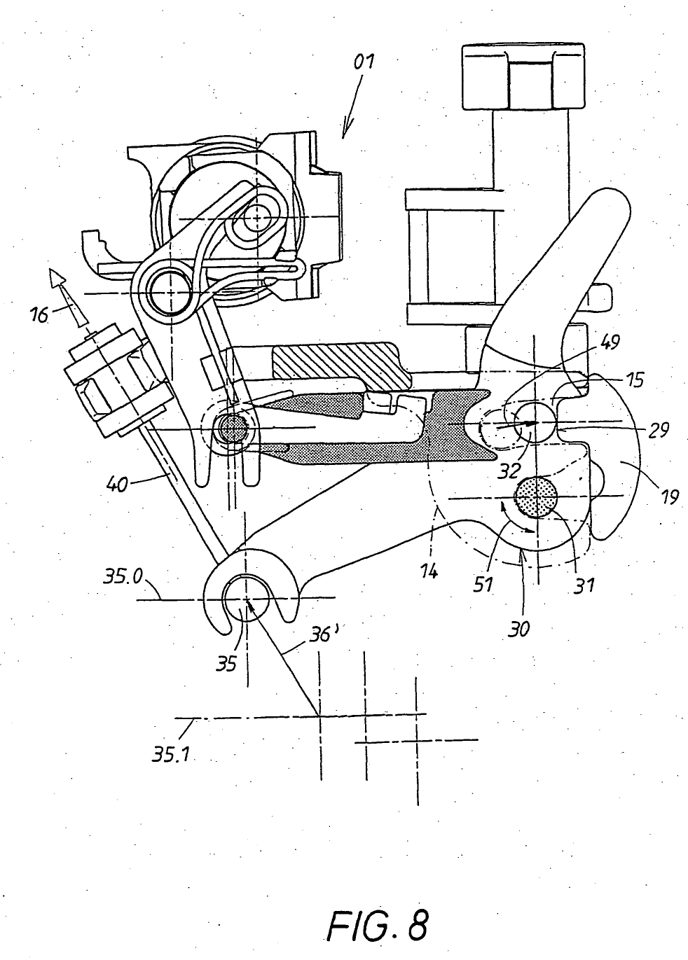

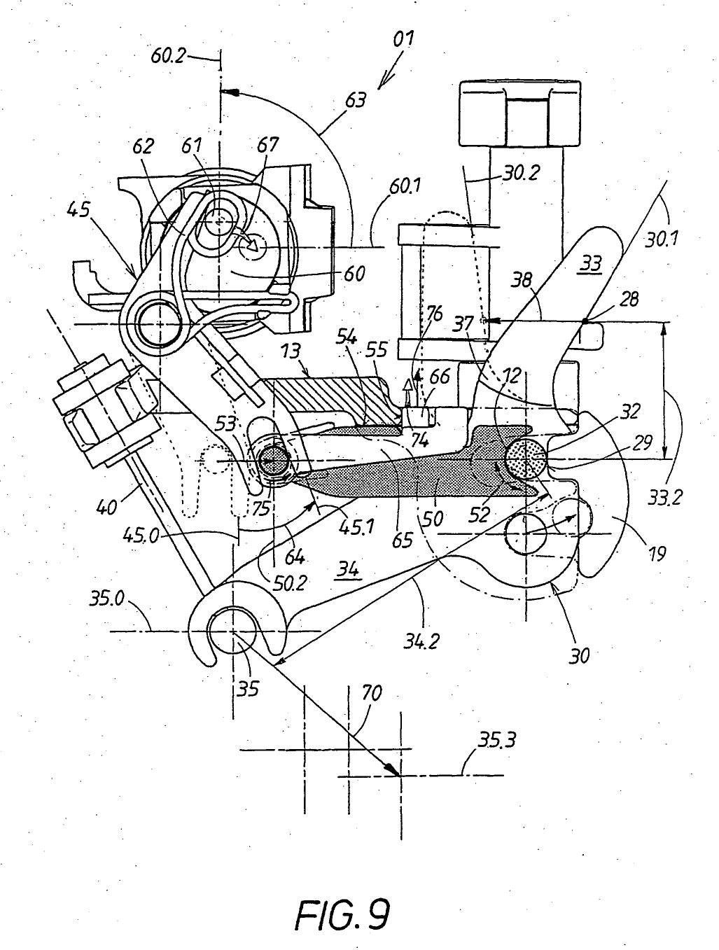

FIGS. 7 and 8, in a view similar to that of FIG. 6, show two additional operating phases of the device in the normal case, namely, the phase in which the handle is fully actuated (FIG. 5) and the later phase in which the handle has reached its home position (FIG. 6);

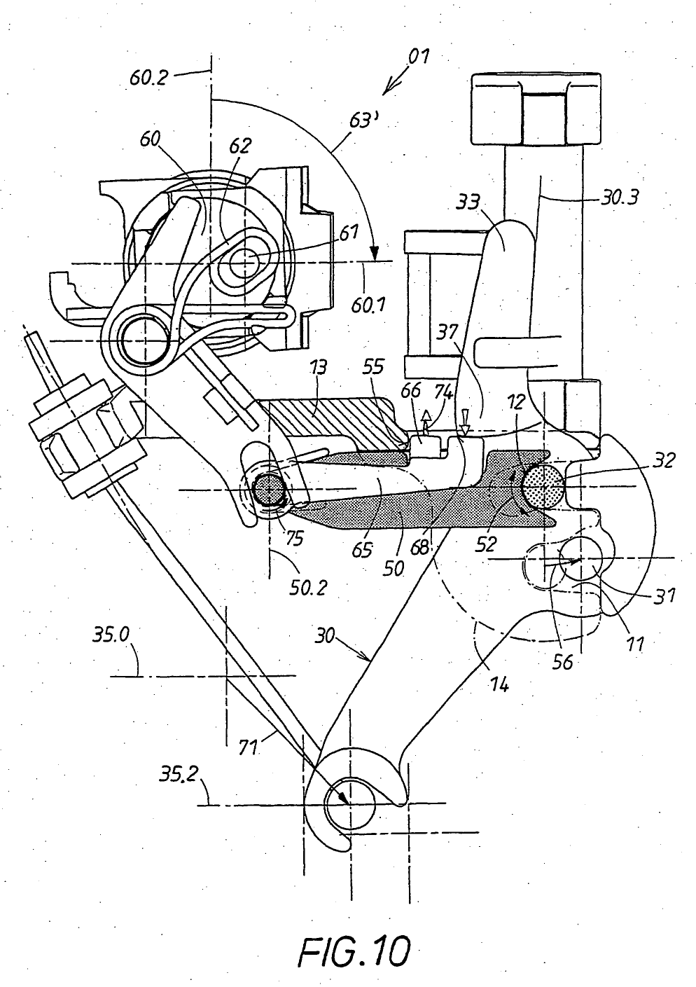

FIG. 9 shows the same components as in FIG. 7; although here the handle is in its home position, the door lock is in its securing position, and the lock cylinder has already been turned by a key or by a turning of the handle into the released position to allow the “emergency actuation” of the device;

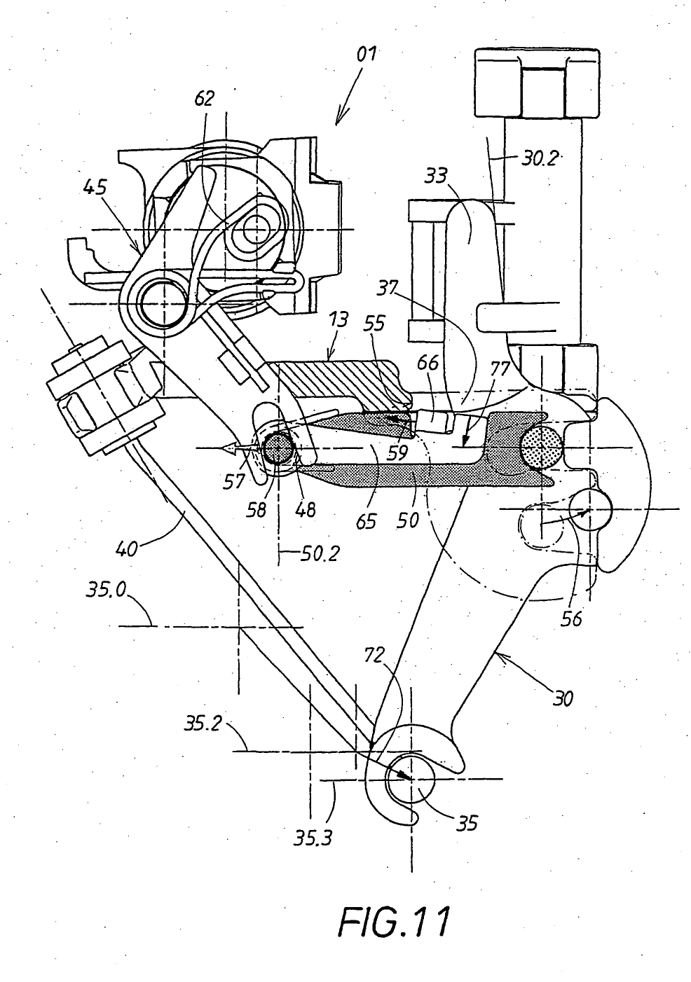

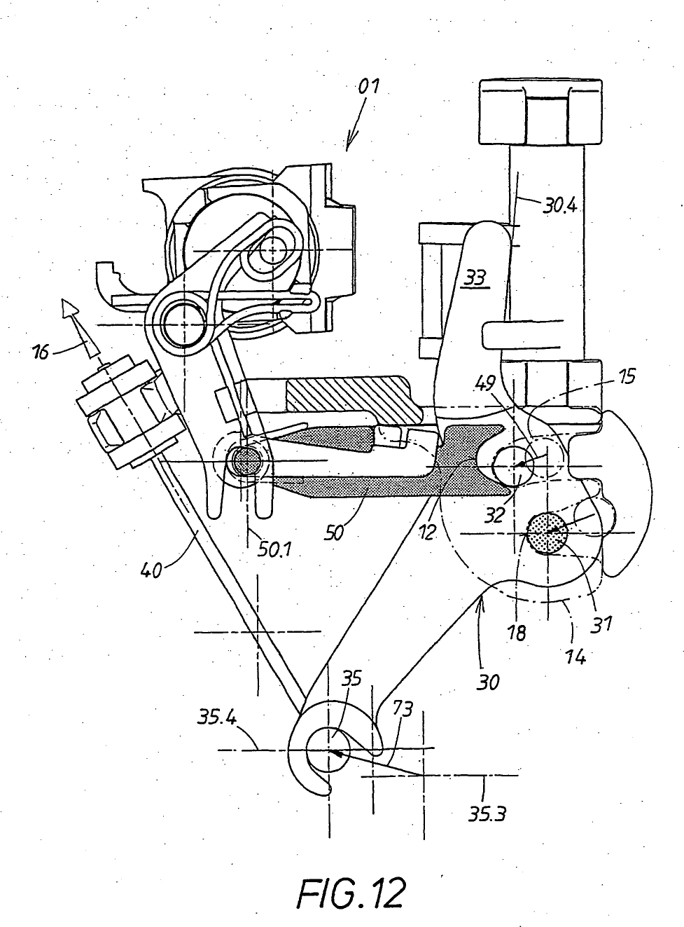

FIGS. 10 and 11, proceeding from FIG. 9, show two subsequent phases of the emergency actuation procedure, the handle being partially actuated in FIG. 10 and fully actuated in FIG. 11, where the lock cylinder has already been returned automatically by the force of an impulse spring from its preceding released position to its null position;

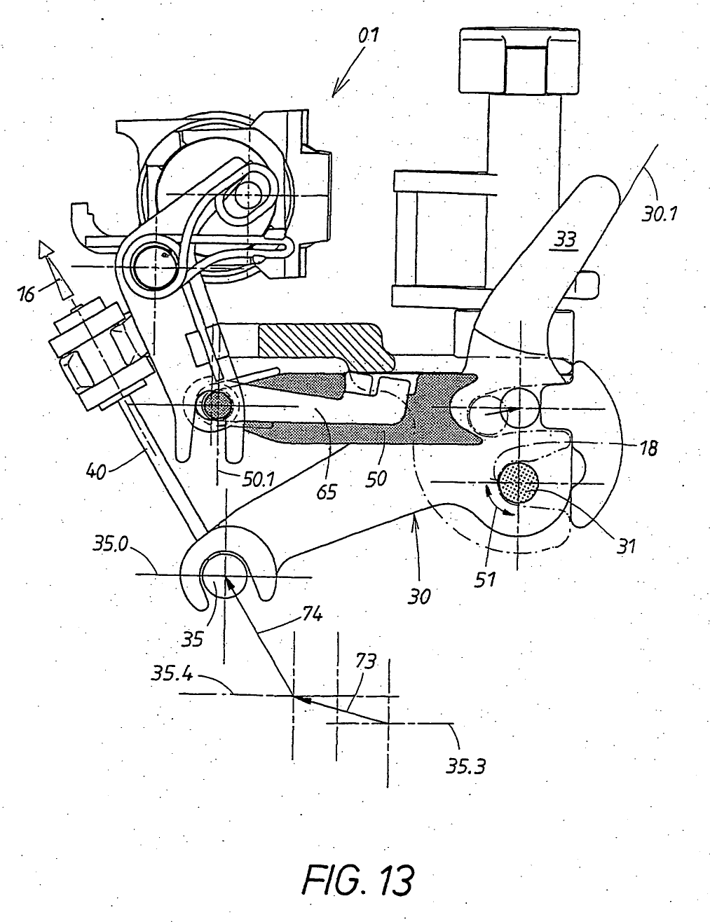

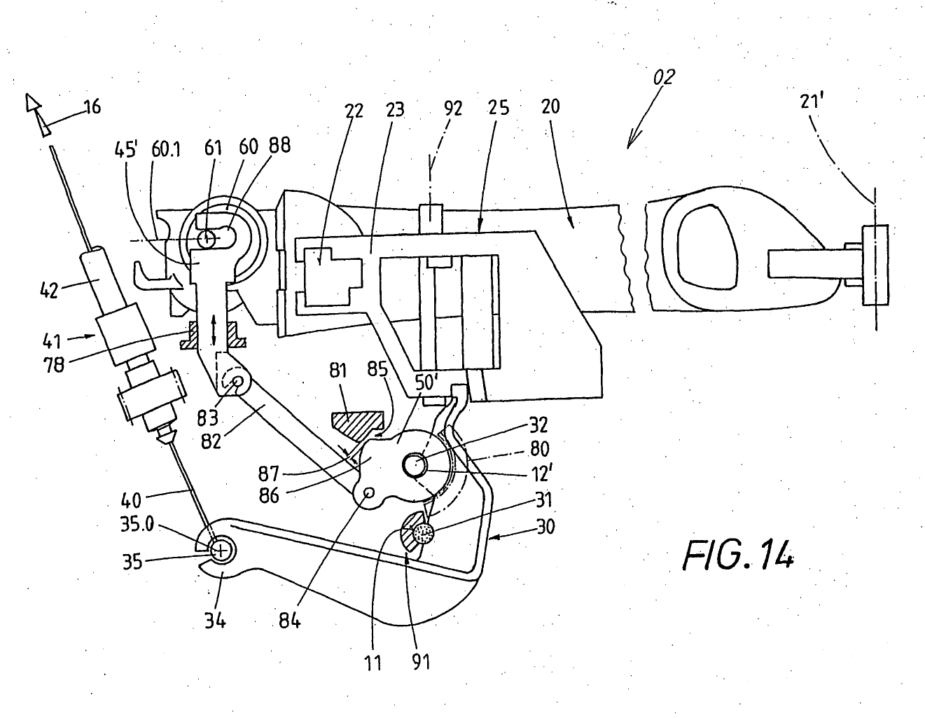

FIGS. 12 and 13, proceeding from FIG. 11, show these components in the positions that result after the return movement of the handle, namely, in an intermediate position (FIG. 12) and in an end position (FIG. 13), corresponding again to the home position of the handle;

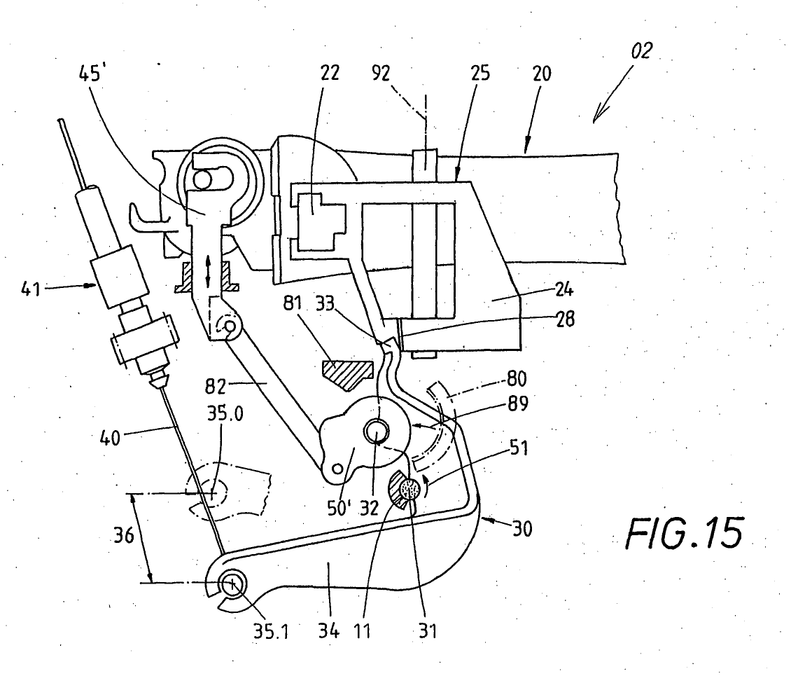

FIG. 14, in a view corresponding to that of FIG. 6, shows the components of a second embodiment of the first variant of the device according to the invention, when the lock cylinder is in its null position, the handle is in its home position, and the door lock is already in the released position;

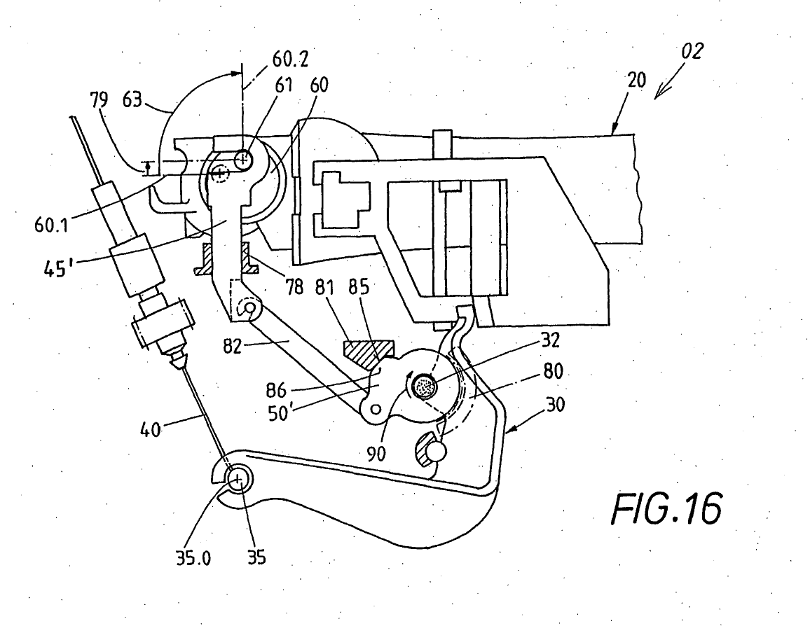

FIG. 15, in a view corresponding to that of the first exemplary embodiment in FIG. 7, shows the operating phase which results in the second exemplary embodiment according to FIG. 12 when the handle is in its fully actuated position;

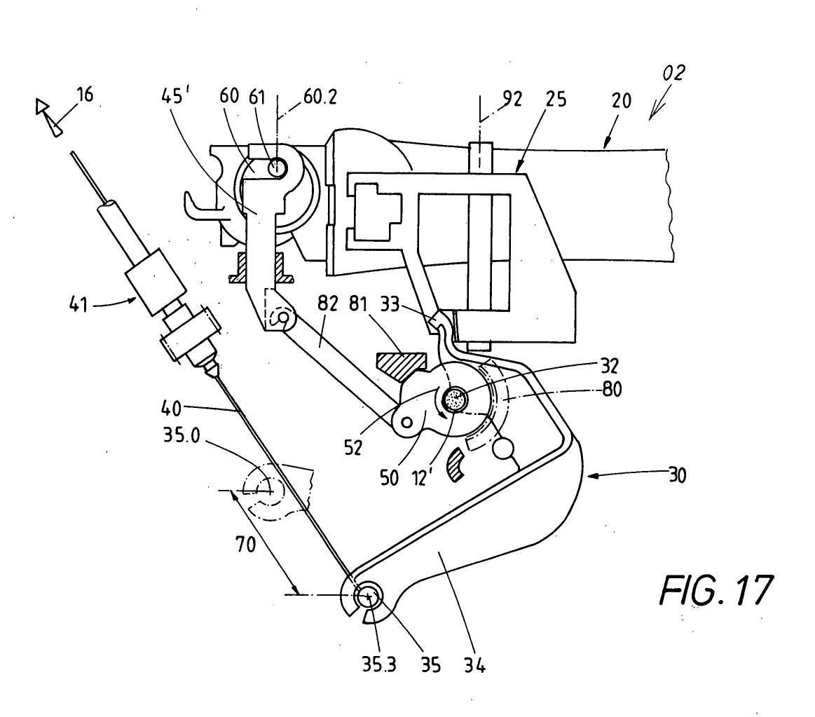

FIG. 16, in a view corresponding to that of FIG. 9 of the first exemplary embodiment, shows the second exemplary embodiment of the device according to the invention, where, although the handle is still in its home position, the door lock is in a locking position, and the lock cylinder has already been turned by a key or the like into a released position to allow the emergency actuation of the locked device;

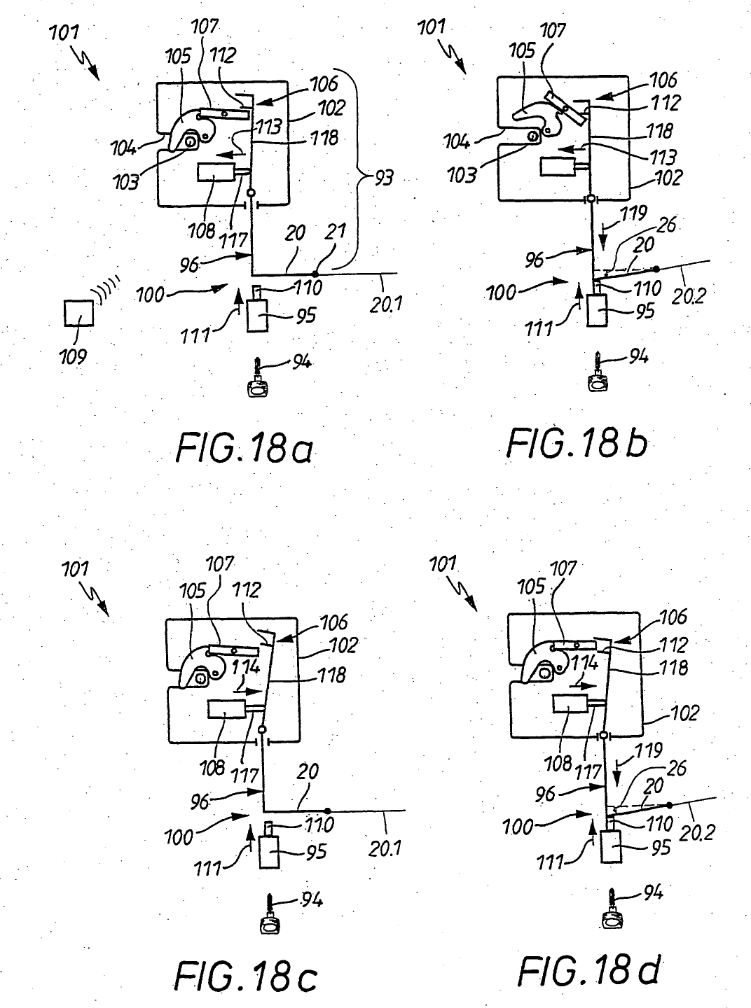

FIG. 17, in analogy to FIG. 11 of the first exemplary embodiment, shows the operating phase that results after FIG. 16, in which the handle has been brought into its actuating position;

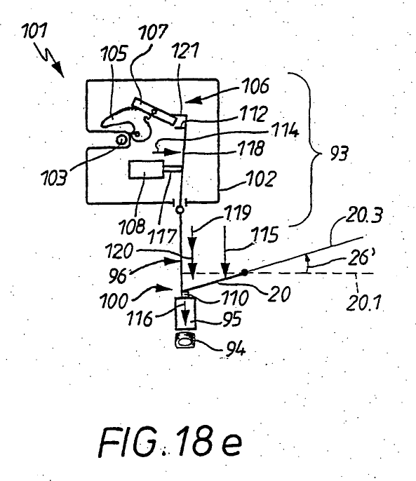

FIGS. 18a-18e show highly simplified schematic diagrams of five different working phases of the second variant of the device according to the invention; and

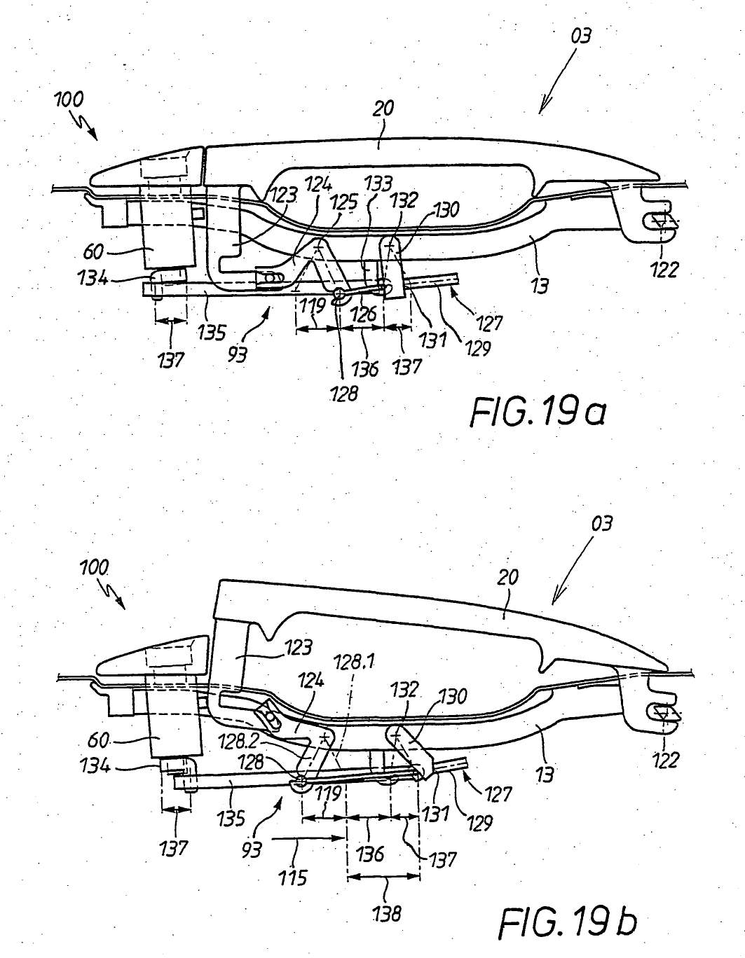

FIGS. 19a-19b show plan views of two different working phases of a third exemplary embodiment of the first variant of the device according to the invention, namely, the home position in FIG. 19a and an emergency actuation position in FIG. 19b.

FIG. 1 illustrates the working principle of the invention on the basis of a functional block diagram. Following a handle 20 mounted on the exterior of the door is first a transfer element 93, which works together with a chain of connecting links 96 for the handle. After this chain comes, first, the door lock 102, which, for example, can have the appearance described in greater detail on the basis of FIG. 16a. The door handle 20 and the transfer element 93 are combined into a single unit 100. This unit 100 is assigned a lock cylinder 95 in the door, which can be actuated from outside the door by an appropriate key 94.

The lock cylinder 95 can be rotated by the key 94 between at least two different positions and thus interacts by way of an output element 97 with the unit 100. In a first rotational position of the lock cylinder 95, the unit 100 is controlled via the output element 97 in such a way that a first working stroke 119 passes via the link chain 96 to the door lock 102. The door lock 102 in the present case can respond to two different working strokes, namely, to the just-mentioned working stroke 119 and to a second working stroke 115, which will be described in greater detail later, and thus initiates different functions accordingly.

In the previously mentioned first rotational position of the lock cylinder 95, a so-called “released” position of the door lock 102 is intended to be present. The actuation 26 of the handle 20 produces the first working stroke 119, as a result of which the door lock 102 opens. When the lock cylinder 95 is in its other rotational position, the so-called “securing” position of the door lock 102 is present. In this position, an actuation 26 of the handle is without effect. If the key 94 is inserted into the lock cylinder 95 and the cylinder is moved to the other rotational position, an output 97 ensures that the structural unit 100 produces the previously mentioned second working stroke 115 of the link chain 96, this stroke being, for example, longer than the previously mentioned first working stroke 119. This second working stroke 115 is detected by the door lock 102 and has the effect that, even though the door lock 102 is in its securing position, it opens when the handle 20 is actuated. This means that the door can be opened in an emergency situation.

As already mentioned above, there are two different ways in which the invention can be realized, both of which are illustrated schematically in the functional block diagram of FIG. 1 and described in detail on the basis of the following exemplary embodiment. A first variant consists in using the two rotational positions of the lock cylinder 95 to perform different actions on the transfer element 93 of the structural unit 100 as indicated by the dotted action line 98 in FIG. 1. When this route 98 is taken, the transmission ratio of the transfer element 93 is changed. Thus, even though the handle 20 is actuated 26 in the same way in each of the two rotational positions, the transmission ratio of the transfer element 93 will be smaller in one of these positions and larger in the other. The smaller ratio has the result of producing the previously mentioned short first working stroke 119 in the handle's link chain 96. In the other rotational position of the lock cylinder 95, the larger transmission ratio of the transfer element 93 is produced by way of the working connection 98, as a result of which the previously mentioned long working stroke 115 occurs. This route is indicated schematically in FIGS. 2a-2c and described in detail on the basis of three exemplary embodiments, namely, a first exemplary embodiment 01 of the device in FIGS. 3-13, a second exemplary embodiment 02 in FIGS. 14-17, and finally a third exemplary embodiment 03 in FIGS. 19a and 19b.

In the other variant of the device according to the invention, the output 97 of the lock cylinder 95 acts on the outside door handle 20, as illustrated by the dashed action line 99 in the functional block diagram of FIG. 1. In the first rotational position, the handle 20 can be actuated only over a short distance 26, as a result of which the previously mentioned short first working stroke 119 is produced by way of the transfer element 93. If the door lock 102 is in its previously mentioned released position, this actuation 23 is sufficient to open the door lock 102. But if the door lock 102 is in its securing position, this actuation 23 is without effect; the door lock 102 remains locked.

The latter situation does not change until the key 94 is used to move the lock cylinder 95 into its other rotational position. In this case, in accordance with the last-mentioned second working principle of the device, a longer actuation distance 26′ of the handle 20 is now possible. This longer actuation distance 26′ ensures that the longer second working stroke 115, already mentioned several times, occurs behind the transfer element 93. Then the door lock 102 can be opened, even though it is in its securing position. The concrete realization of this design principle is explained in greater detail in association with FIGS. 18a-18e.

As already mentioned, the principle of the first variant of the device according to the invention is explained on the basis of the structural unit 100 shown in FIGS. 2a-2c. FIG. 2a shows the handle 20 in its “home” position, illustrated by the auxiliary line 20.1. The handle 20 is supported pivotably at point 21. After the key 94 has been withdrawn, the lock cylinder 95 is in its first rotational position, which puts into effect the previously described first transmission ratio of the connected transfer element 93.

When the handle is actuated 26 as illustrated by the motion arrow 26 in FIG. 2b, the handle 20 arrives in its actuating position, illustrated by the auxiliary line 20.2. The previously mentioned first working stroke 119 takes place at the output of the transfer element 93, this stroke being transmitted to the handle's link chain 96. As already described several times, the door lock can be opened in this situation, if it is in its released position. But if the securing position is present, this working stroke 119 of the handle's chain of links 96 has no effect.

This situation does not change until the measures illustrated in FIG. 2c are taken. In FIG. 2c, the lock cylinder 95 has been moved into its second rotational position by the inserted key 94; this second position puts the previously mentioned larger transmission ratio of the associated transfer element 93 into effect. When now, proceeding from the home position 20.1 of FIG. 2a, the handle 20 is again pivoted by the same distance 26 around its pivot bearing 21, the long working stroke 115, already mentioned several times above, is performed at the output of the transfer element 93; this stroke is then transmitted to the door lock 102 by the handle's link chain 96. When the handle is actuated 26 in this way, the long working stroke 115 acts on the door lock in such a way that the door lock is switched from its securing position to its released position. Then the situation is again the same as that shown in FIG. 2a. When the door handle 20 is actuated again over the same actuating distance 26 according to FIG. 2b, the door lock will be opened.

As previously mentioned, a first exemplary embodiment 01 of the first variant of the device according to the invention is illustrated in detail in FIGS. 1-14. FIG. 3 shows a door 10 in dash-dot line, to which a bracket 11 [Sic; 13—JPD] belonging to the device 01 is attached. Various components are mounted on this bracket 11.

These components include, first, a handle 20, designed here as a so-called “pull handle”, which is pivotably supported on the bracket 13 at 21; the opposite, free end 22 of the handle works together with the driven arm 23 of a reversing lever 25, best seen as the shaded component in FIG. 5. The home position of the handle 20 is shown in solid line in FIG. 5, emphasized by an auxiliary line 20.1. By pulling on the handle 20 in the direction of the arrow 26, the handle 20 arrives in the actuating position 20.2 illustrated in dash-dot line in FIG. 5. Thus a first arm 33 of a transfer lever 30, referred to below in brief as the “input arm”, is contacted by a second driving arm 24 of the reversing lever. When the handle is actuated 26, the input arm 33 moves out of its previous starting position 30.1, marked by the auxiliary line 30.1 in FIG. 4, into its actuating position 30.2, drawn in solid line and dotted line in FIG. 5. The handle 20 and the transfer lever 30 form the structural unit 100, previously mentioned several times, which is seated on the bracket 13.

As can be seen in FIG. 4, the transfer lever 30 also has a second arm 34, which will be referred to below as the “output arm”. A chain of connecting links, which is to be referred to below because of its special design as the connection 40, is connected to the free end of the output arm 34 by means of a joint 35 and leads to the door lock (not shown). This connection 40 consists in the present case of the core of a Bowden cable 41, the entire length of which can be seen in FIG. 3, the sleeve 42 of which is attached to an extension 43 of the bracket 13. When the handle is actuated 26 in the previously mentioned normal case according to FIGS. 6-8, the connecting point 35 of the connection 40 is moved by the transfer lever 30 out of the home position shown at 35.0 in FIG. 6 into the actuating position 35.1 shown in FIG. 7, the position of which can also be seen in FIG. 6. As a result, the working stroke of the connection 40 illustrated by the arrow 36 in this figure is produced.

A special feature of the invention is that the transfer lever 30, as can best be seen in FIG. 4, has two bearing journals 31, 32, each of which has its own bearing seat 11, 12, as can be seen in FIG. 6. As can be seen from FIGS. 4 and 6, one of the bearing seats 11, namely, the one assigned to the bearing journal 31, is located in a bearing cover 14 seated on the bracket 13, whereas the other bearing seat 22 is at the free end of a control element 50, mounted underneath this bearing cover 14. This control element 50 is emphasized by dotted shading in FIGS. 6-12 to make it easier to see. It can also be derived from FIGS. 4 and 6 that the second bearing journal 32 passes through a longitudinal slot 15 in the bracket-side bearing cover 14. Only the outline of the bearing cover 14 is shown (in dash-dot line) in FIGS. 6-13, so that the components located underneath the bearing cover 14 can be seen.

In the normal case according to FIGS. 6-8, the elements 31, 11 define a first bearing position for the transfer lever 30. A restoring force 16 acts on the output arm 34 of the transfer lever 30, and the input arm 33 is supported on the contact point 28 of the driving arm 24 of the reversing lever 25. The reversing lever 25 is also acted upon by a restoring force 17, indicated in FIG. 5. The former restoring force 16 originates from the Bowden cable 41 and tries to hold the connection 40 in its home position 35.0 of FIG. 6. The other restoring force 17 is generated by a “sidepiece” type spring 27, shown in FIG. 4, which acts on the reversing lever 25 and tries to keep its second arm 24 in the home position of FIG. 6. As a result, the journal 31 is held in the base 18 of the open seat 11, the opening of which is covered by a stationary bearing cap 19 belonging to the bracket 13, this cap being a safe distance away from the journal. The cap 19 has an opposing surface 29, which fits into the longitudinal slot 15 behind the second bearing pin 32. In the home position 20.1 of the handle, which leads to the starting position 30.1 of the input arm 33, it is possible for the second bearing journal 32 to make contact with the opposing surface 29 as if it were a stop.

The “sidepiece” type spring 27, as illustrated in FIG. 5, can also ensure, by way of the reversing lever arm 23, a return of the actuated handle 20 in the direction of the restoring arrow 26″ from its actuating position 20.2 to its home position 20.1. This return occurs during the transition from FIG. 7 to FIG. 8. In FIG. 7, the actuating hand is still gripping the handle. In FIG. 8, the hand has let go of the handle 20. Because of the restoring force 17, the connecting point 35 of the connection 40 executes a return stroke 36′ in FIG. 8; the connecting point 35 thus returns from its actuating position 35.1 to its home position 35.0.

While the transfer lever 30 is being rotatably supported on its first bearing journal 32, as illustrated by the dotted shading of the journal 32 in FIGS. 6-8, the arm lengths of the output arm 34 and the input arm 33 of the lever are as designated at 30.1 and 34.1 in FIG. 6. This has the effect of creating a certain transmission ratio when the transfer lever 30 is rotated, as indicated by the arrow 51 in FIG. 6. In the exemplary embodiment shown here, the ratio of the lengths 34.1 of the output arm 34 to the length 30.1 of the input arm 33 might be approximately 1.4. The contact point 28 of the driving arm 24 of the reversing lever 25 with the input arm 33 of the transfer lever 30 shown in FIG. 6 travels a distance 38, also shown in FIG. 6, when the handle 20 executes the complete actuating stroke 69 of FIG. 5. Because of the transmission ratio present at the time, the connection 40 at the end of the output arm 34 executes either the previously described working stroke 36 or the reverse stroke 36′ shown in FIG. 8.

A lock cylinder 60 is also rotatably supported on the bracket 13; this cylinder can be turned by a key (not shown) from one position to at least one other position. At the inner end of the cylinder, the lock cylinder 60 has an output in the form of a cylindrical bolt 61, which is eccentric with respect to the axis of the cylinder, this bolt being held by a spring 62 in the rotational position indicated by the auxiliary line 60.1 in FIG. 6. This rotational position 60.1 is the so-called “null” position of the lock cylinder 60. The spring 62 performs a double function. The spring 62 is designed with two sidepieces and has turns, which allow it to act as a so-called impulse spring on the lock cylinder 60; after a rotation 63 by means of a key according to FIG. 8, the spring automatically returns the cylinder to its null position 60.1 again as shown by the reverse rotation arrow 63′ in FIG. 10. This is the first function of the spring 62.

As can be seen in FIG. 6, there is also a driver 45, which is nonpositively supported on the cylindrical bolt 61; this driver is pivotably supported on the bracket 13 by a bearing 44, which is eccentric to the axis of the cylinder. The driver 45 acts on the previously mentioned control element 50. For the sake of clarity, this control element 50 is emphasized by dotted shading in FIGS. 6-13. The driver 45 consists here of an angle lever with two arms 46, 47, which, as shown in FIG. 6, are spring-loaded by the spring 62 in the clockwise direction. As a result, the previously mentioned nonpositive contact is produced between the arm 46 of the driver 45, i.e., the arm which acts as the drive arm for the control element 50, and the cylindrical bolt 61. The second arm of the angle lever 45, to be called the “takeoff” arm 47, has a fork 48, in which a pin 58 engages. The pin 58 is seated on the end of the control element 50 opposite the bearing seat 12. The fork 48 and the pin 58, which can slide in the fork, form a so-called “link guide” between the two components 45, 50.

In the null position 60.1 of the lock cylinder according to FIGS. 6-8, the driver 45 with its takeoff arm 47 occupies the null position indicated by the auxiliary line 45.0. In this null position, the control slider 50 is pushed so far back (by way of the previously mentioned link 48, 58) that, upon the previously described rotation 51 around the first bearing journal 31, the previously mentioned bearing seat 12 on the control element 50 is located a safe distance away from the second bearing journal 32, which is thus inactive during this rotation 51. Nevertheless, a slight, completely insignificant contact between the seat and the second bearing journal 32 can occur, as shown in FIG. 7, when, upon the rotation 51, this journal is moved out of its home position indicated in dash-dot line and into the pivoted position shown in solid line. This pivoting movement occurs over a distance 49. The pivoting distance is determined by the angle of rotation of the transfer lever 30 between the two positions shown in FIG. 6, namely, between the starting position 30.1 and the actuating position 30.2.

When the handle 20 is released and the return stroke 36′ shown in FIG. 8 is initiated, the second bearing journal 32 travels by this distance 49 back into its home position indicated in solid line in FIG. 8, which position is characterized by contact with the opposing surface 29 of the previously mentioned bearing cap 19. As FIGS. 7 and 8 illustrate, the longitudinal slot 15 in the bearing cover 14 shown in dash-dot line is large enough to permit this pivoting movement 49 of the second bearing journal 32; the second bearing journal 32 thus moves freely. These relationships characterize the previously mentioned “normal case” of the device.

In modern devices, as already mentioned, the securing position and the released position of the door lock are controlled by an electronic key. In the securing position, an actuation 26 of the handle 20 is without effect, but after the door lock has been released, such an actuation will be successful. A mechanical actuation of the lock cylinder 60 by means of a key is not usually necessary. It is necessary, however, after the electrical power supply or one of the electronic components has failed, as already described. Then the operator is forced to perform an “emergency actuation” of the door lock by the use of a mechanical key. Then the lock cylinder 60, as already mentioned and as illustrated in FIG. 9, is subjected to a key-actuated rotation 63, as a result of which the cylindrical bolt 61 is moved out of the null position 60.1 shown there in dash-dot line into the released position 60.2 drawn in solid line and marked by an auxiliary line 60.2. In the invention, this rotation 63 of the lock cylinder is not, as was conventional in the past, transmitted by its own separate chain of connecting links to the door lock; instead, it occurs by way of the same link chain as that associated with the manual actuation 26 of the handle, namely, via the connection 40.

This is achieved according to the invention by allowing the driver 45, which pivots concomitantly with the lock cylinder 60 under the action of the cylindrical bolt 61, to act by way of the control element 50 on the transfer lever 30 in a particular way. That is, the takeoff arm 47 of the driver 45 pushes the control element 50 by its pin 58 out of the inactive position present in the normal case shown in FIG. 6, marked by the auxiliary line 50.1, into the active position, marked by a corresponding auxiliary line 50.2 in FIG. 9. The control element 50 is thus pushed by the distance 53, indicated by the arrow in FIG. 9. In the present exemplary embodiment 01, the control element 50 consists of a slider, which is guided by the guide surface 54 on the bracket 13. A catch 65, which is provided with a latching projection 66, is able to move concomitantly with the slider 50. The catch 65 is spring-loaded by a spring 39, previously indicated in FIG. 4, in the direction of the force arrow 74 of FIGS. 6 and 10. The catch 65 moves along with the control element 50 because it is supported on the pin 58 of the control element; the catch 65 can also pivot around this pin. In the normal case, shown in FIGS. 6-8, the latching prong 66 comes to rest against the guide surface 54 and is therefore inactive initially. In this situation, the control element 50, to which the catch 65 is connected, can be slid in the direction of the arrow 53 in FIG. 9. The guide surface 54 on the bracket 13 guides the sliding movement of the latching prong 66. This changes as soon as the conditions illustrated in FIG. 9 are present.

In FIG. 9, the control element 50 has been pushed by the distance 53 and thus has now reached its previously mentioned active position 50.2. Now, as a result of the previously mentioned spring-loading 74 acting in the direction of the motion arrow 76, the latching prong 66 can snap into place behind a stationary shoulder 55 belonging to the bracket 13. The spring 39 exerts a torque on the catch 65, as illustrated by the arrow 75 in FIG. 9. Thus the active position 50.2 of the control element 50 is initially secured by the catch 65. The bearing seat 12 at the front end of the control element 50 has now made contact with the second bearing journal 32 and works together with the opposing surface 29 of the bearing cap 19 to make this journal capable of acting as a pivot bearing. When an actuation 26 of the handle 20 occurs, which, again, moves the input arm 33 of the transfer lever 30 out of its starting position 30.1 of FIG. 3 into the actuating position 30.2 of FIG. 10, rotation 52 now occurs around the second bearing journal 32. The active state of the bearing journal in FIGS. 9-11 is again emphasized by dotted shading. The reason for this is that, when the second bearing seat 12 is in the position of FIG. 9 in which it can function as a bearing, it is physically impossible for the second bearing journal 32 to execute the pivoting movement 49 of which it was capable in the normal case according to FIG. 7. When the control element 50 is in the active position 50.2, the free space in the longitudinal slot 15 of the bearing cover 14 drawn in dash-dot line, is blocked, as can be seen in FIG. 7. In contrast, as FIGS. 10 and 11 show, the first bearing journal 31 can move freely in the direction of the pivot arrow 56 in its open bearing seat 11 in the bearing cover 14, drawn in dash-dot line. In FIGS. 9-11, the first bearing journal 31 is thus unable to function as a bearing.

As previously described, FIG. 10 shows the situation of the lock cylinder 60 after the key has been released. Because of the previously mentioned restoring action of the spring 62 acting on it, the lock cylinder 60 is returned automatically by way of its cylindrical bolt 61 from the released position 60.2 of FIG. 9 to its null position 60.1. A reverse rotation 63′ of the lock cylinder 60 takes place. Nevertheless, the control element 50 remains in its active position 50.2. This is so because the latching prong 66 is still locked behind the stationary shoulder 55 of the bracket 13, as previously described. The second bearing point 12, 32 on the transfer lever 30 therefore remains active; rotation 52 occurs around the bearing journal 32.

FIG. 10 also shows the first phase of the handle actuation 26, where the handle 20 has executed approximately 90% of its actuating stroke 69 of FIG. 5. This is indicated by the intermediate position of the input arm 33 of the transfer lever 30, marked by the auxiliary line 30.3. The connecting point 35 of the connection 40 leading to the lock has moved by the distance 71 away from its home position 35.0 in FIG. 9 into an intermediate position labeled 35.2 in FIG. 10. As can be seen from the marks in FIG. 10, this intermediate position 35.2 also deviates from the actuating position 35.1 of FIG. 7, which occurs in the normal case. This can be explained by the different transmission ratio of the transfer lever 30 that results in the emergency actuation case of FIGS. 9-13.

After the handle has been subjected to further actuation 26 and has traveled the remainder of the complete actuating stroke 69 of FIG. 5, the input arm 33 of the transfer lever 30 finally arrives in its actuating position 30.2 of FIG. 11. The connecting point 35 of the connection 40 has now traveled the final distance 72, designated by the number 72 in FIG. 11, which produces the emergency actuating position 35.3, designated 35.3 in FIG. 11. To reach this emergency state, the connecting end 35 of the connection 40 has had to travel a distance equal to the long working stroke 70 shown in FIG. 9.

The transmission ratio is changed because of the different ratio that exists in the emergency case of FIG. 9 between the lengths of the two arms 33, 34 of the transfer lever 30. The arm lengths are now to be seen in relation to the second bearing journal 32 and thus now have the lengths indicated at 33.2 and 34.2 in FIG. 9. The transmission ratio between the length 34.2 of the output arm 34 to the length 33.2 of the input arm 33 might now be 2.2. In any case, the working stroke 70 is much longer in the emergency case than the working stroke 36 in the normal case. This difference in distances between 70 and 36 is detected by the door lock, which initiates the corresponding functions. In the case of the short working stroke 36, the door lock recognizes that a “normal” case is present and opens the door. But when the long working stroke 70 has occurred, the door lock recognizes that the “emergency” case is present, and the door lock, which has up to then been in the securing position, moves to its released position. The following actuation of the handle thus opens the door again. In the emergency case, however, this opening movement can also be made to occur during the last phase of the handle actuation 26. That is, the door lock can be provided with, for example, suitable sensors, which respond to the difference between the working strokes 36, 70. As FIG. 9 illustrates, the back-and-forth movement leads to a drive path 38 of the input arm 33 of the transfer lever 30, which is the same as that of the normal case of FIG. 6. In both cases, namely, in the normal case according to FIGS. 6 and 7 and in the emergency case according to FIGS. 9-11, exactly the same actuating stroke 69 shown in FIG. 5 takes place.

In the last phase of the handle actuation 26 in the emergency case, as shown in FIGS. 10 and 11, the device is returned automatically to the normal state of FIG. 6. For this purpose, use is made of the pivoting movement 52 of the transfer lever 30. In the present case, a cam 37 is provided, which just makes contact with a control surface 68 on the catch 65 when in the lever is in the intermediate position 30.3 shown in FIG. 10. Upon completion of the remaining actuating stroke 69 of FIG. 5, the cam 37 presses the latching prong 66 of the catch out of engagement with the stationary shoulder 55 of the bracket 13, as illustrated by the motion arrow 77 in FIG. 11. The catch 65 no longer holds the control element 50 in its active position. The restoring force 57 exerted by the spring 62 on the driver 45, as shown by the force arrow 57 in FIG. 11, moves the control element 50 in the direction of the reverse motion arrow 59 back into its inactive position 50.1 as a result of the working connection at 48, 58.

The result of this reverse movement 59 can be seen in FIG. 12. The bearing seat 12 of the control element 50 has already released the second bearing journal 32. In FIG. 12, the handle 20 has been let go, for which reason it executes its return movement 26′ of FIG. 5 under the action of the previously mentioned restoring forces. In FIG. 12, the connecting point 35 travels back the way it came, namely, by the initial distance 73 indicated by the arrow in FIG. 12, up as far as the intermediate return-stroke position 35.4. As a result of the previously mentioned restoring force 16, the first bearing journal 31 has already arrived in the position where it is able to function as a bearing in its assigned bearing seat 11 in the bearing cover 14 shown in dash-dot line. As emphasized by the dotted shading, the first bearing journal 31 is already able to function as a pivot bearing in FIG. 12, whereas the second bearing journal 32 has been released by the control element 50 and is no longer able to function as a bearing. In FIG. 12, the second bearing journal 32 has moved freely back in the longitudinal slot 15 from the rotational position in which it was still able to function as a bearing, indicated in dash-dot line in FIG. 11, in the direction of the pivot arrow 49 (in analogy to FIG. 7), even though the input arm 33 of the transfer lever 30 is still in the intermediate reverse-pivoted position 30.4 in FIG. 12.

In FIG. 12, the bearing relationships of the normal case of FIGS. 6-8 are already present again. For this reason, the previously described intermediate return-stroke position 35.4 of the connecting point 35 can be the same as the operating position 35.1 described in association with FIGS. 7 and 8. The rest of the reverse rotation of the control element 50 to its starting position 30.1 shown in FIG. 13 takes place again through the rotation 51 around the first bearing journal 31. The connecting point 35 moves back along the final section 74 of the reverse stroke marked by the arrow 36′ in FIG. 13 until the connection 40 has again reached is home position 35.0 of FIG. 13. The length 36′ of this return stroke corresponds to that of the return stroke according to FIG. 8 in the normal case.

As can be seen in FIGS. 10-13, the way in which the transfer lever 30 is supported is different in the emergency case. During the working stroke 70 according to FIGS. 9, 10, and 11, the second bearing journal 32 is operational. During the return stroke, however, an automatic switch of the rotational support takes place to the first bearing journal 31 of the transfer lever 30. The device resets itself automatically from the relationships characterizing the emergency case back to those characterizing the normal case.

The second exemplary embodiment 02 of the first variant of the device according to the invention shown in FIGS. 14-17 differs from that of the previously described first exemplary embodiment 01 essentially in two different ways. First, the control element in this case is designed as a pivoting part 50′. In addition, a thrust element 45′ is used as a driver, which is next to the lock cylinder 60 and is pushed longitudinally in the direction shown by the arrow 79 in FIG. 14 in a stationary guide 78 during the actuations to be described below. The bracket 13 shown in the first exemplary embodiment 01 has been, for the sake of clarity, omitted for the most part from the second exemplary embodiment 02 in FIGS. 14-17; the only parts of it which remain are the components 78, 81, 91, emphasized by hatching, which will be explained in greater detail below. To designate the other elements, the reference numbers of the first exemplary embodiment are used, for which reason the same reference numbers are used to name them. To this extent the previous description also applies here. Only the differences will be discussed.

At one end the thrust element 45′ has an opening 88, which is oriented transversely to the previously mentioned longitudinal sliding direction 79 and in which the eccentric cylinder bolt 61, described in the first exemplary embodiment 01, engages. In FIGS. 12 and 13, the lock cylinder 60 is in the “null” position, as indicated by the auxiliary line 60.1, in which, as in the first exemplary embodiment, the cylinder is held by appropriate restoring springs. A connecting rod 82 is connected to the other end of the thrust element 45′ by way of a joint 83. Via the connecting rod 82, the position of the thrust element 45′ at the moment in question is transferred to the pivoting part 50′, which can therefore be brought into various defined pivot positions.

The pivoting part 50′ is pivotably supported on the transfer lever 30. The second bearing journal 32 seated on this transfer lever 30 is used for this purpose. The pivoting part 50′ thus has a bearing bore, which in the present case provides a closed bearing seat 12′ for this second bearing journal 32. A stationary guide segment 80 is assigned to the pivoting part 50′; this guide segment is a component of the bracket, mentioned several times above, and which is indicated only in dash-dot line in FIGS. 14-17 so that the components present underneath it can be seen. The guide segment 80 not only guides the pivoting part 50′ during the rotation which occurs between FIG. 14 and FIG. 16, as indicated by the arrow 90, but also allows the pivoting part 50′ to be lifted away 89, as shown in FIG. 15.

A stationary stop 81 is also assigned to the pivoting part 50′; this stop has an angled profile 85 and, as previously mentioned, is a component of the bracket, not shown in these series of figures. Another component of the bracket is a bearing seat 11, which is open here as well, for the first bearing journal 31, which is also seated on the transfer lever 30. The bearing shell 91 indicated by the hatching in FIGS. 14-17 forms the bearing seat 11.

FIG. 14 shows, as already stated in the listing of the figures, the home position of the handle 20, which is being observed in FIGS. 14 and 17 from the perspective of the inside surface of the door. This again is a so-called “pull handle” with a pivot axis, indicated by the dash-dot line 21′ in FIG. 14, at one end of the handle. The other end 22 of the handle is again engaged with a first arm 23 of a two-armed reversing lever 25, which turns around the vertical lever axis 92 in the bracket (not shown), this axis also being illustrated in dash-dot line in FIG. 14. The reversing lever 25 is normally held in the starting position shown in FIGS. 14 and 16 by restoring springs (not shown); this starting position is present when the handle 20 is in the home position shown in these figures. When the lock cylinder 60 is in the previously mentioned null position 60.1 of FIG. 14, the pivoting part 50′ assumes the pivot position shown in FIG. 14, in which a contact lobe 86 on the pivoting part 50′ has already taken up a position a certain distance 87 away from its stop 81. The contact lobe 87 has been rotated away from the angled profile 85 of the stop 81.

The operating state of FIG. 14 corresponds to that of FIG. 6 of the first exemplary embodiment. When, in the home-position operating state shown in FIG. 14, the handle 20 is pulled around its vertical axis 21′, the state shown in FIG. 15 is produced, which is similar to the actuating position of the handle of FIG. 7 in the first exemplary embodiment 01. As can be seen in FIG. 15, the connection at 22 allows the handle 20 to carry the reversing lever 25 along with it, as a result of which the contact point 28 provided on the second arm 24 of the lever carries the input arm 33 of the transfer lever 30 along. The pivoting part 50′ thus rotates 51 on the bearing elements 31, 11. During the pivoting movement 51, the pivoting part 50′ pivotably supported at 32 is carried along as well, and the previously mentioned lifting-away 89 from the guide 80 occurs. This lifting-away movement 89 is not impeded by the stop 81 opposite the guide segment 80; the pivoting part 50′, which rotates concomitantly with the transfer lever 30, passes by the stop 81 without interference. During this rotation 51, the pivoting part 50′ remains connected to the thrust element 45′ via the connecting rod 82.

In the second exemplary embodiment of FIGS. 14-17, the connection to the lock (not shown) also consists of a Bowden cable 41, the core 40 of which acts on a connecting point 35 between the core and the second arm 34 of the transfer lever 30. In this case, too, the restoring force 16 acting on the core 40 ensures that the first bearing elements 11, 31 remain operational. This is illustrated in FIGS. 14 and 15 by the dotted shading of the first bearing journal 31. In the home position of FIG. 14, the result again, in analogy to the first exemplary embodiment 01, is a home position 35.0 of the connecting point 35, which, when the handle 20 is in the actuating position of FIG. 15, changes to the actuating position marked 35.1. In this normal case, the Bowden cable 41 executes a working stroke 36, shown in FIG. 15. This relatively short working stroke 36 has the effect of releasing the door lock, so that the door can be opened.

As explained in the first exemplary embodiment 01 on the basis of FIG. 9, the relationships shown in FIG. 16 are present when a door lock in the securing position must be opened in an emergency by a mechanical key. This is done by means of a mechanical key (not shown), which is inserted into the lock cylinder 60 of FIG. 16 to rotate the cylinder bolt 61 out of its null position 60.1 shown in dash-dot line in FIG. 16 to the released position labeled 60.2. Because the cylinder bolt 61 is engaged in the recess 88, the thrust element 45′ is carried along during this rotation 63. The previously mentioned longitudinal displacement 79 of the thrust element 45′ in the guide 78 thus occurs, as a result of which, via the connecting rod 82, the pivoting part 50′ is rotated in its guide segment 80. As a result, the contact lobe 86 of the pivoting part 50′ becomes supported against the angled profile 85 of the stop 81. In analogy to FIG. 9 of the first exemplary embodiment, FIG. 16 shows the home position of the handle 20. In FIG. 16, the connecting point 35 of the connection 40 is located again in the home position 35.0, which was already present in FIG. 14 as well. When, proceeding from the FIG. 16, the handle 20 is actuated, the relationships then shown in FIG. 17 are obtained in the emergency case.

In FIG. 17, in the same way as in FIG. 15, the input arm 33 of the transfer lever 30 has been carried along via the rotation of the reversing lever 45 around its axis 92. Because the pivoting part 50′ is now being held in place between the stop 81 and the guide segment 80, the transfer lever 30 now rotates around its second bearing journal 32. The bearing bore 12′ is now operational along with the bearing pin 32. The rotation 52 of the transfer lever 30 now takes place at a different point 12′, 32 than the rotation 51 in the preceding normal case of FIG. 15 at the first bearing point 11, 31. Again, the dotted shading in FIGS. 16 and 17 illustrates that this second bearing journal 32 is now functional.

In the emergency case according to FIGS. 16 and 17, the transfer lever 30 has a different transmission ratio than it does in the normal case of FIGS. 14 and 15. Proceeding from its home position 35.0, the connecting point 35 travels to the end position marked 35.3 in FIG. 17. In this emergency case, a longer working stroke 70 is thus produced. As in the first exemplary embodiment 01, this is detected by the associated door lock, which is connected by the connection 40 to the transfer lever 30 at 35. As a result, the door lock is unlocked.

When the operator lets go of the key, the lock cylinder 60 can again be moved back by a restoring spring (not shown) from its released position 60.2 of FIG. 17 to its null position of 60.1 of FIG. 14. A similar sequence of events occurs when the handle 20 is released. The door lock is unlocked, and the original relationships of FIG. 14 are therefore restored. As a result of another actuation of the handle 20, as already described in association with FIGS. 14 and 15, the door lock is opened.

In this case, too, as in the first exemplary embodiment 01, latching means can also be provided, which, in analogy to FIGS. 9, 10, and 11 of the first exemplary embodiment, hold the pivoting part 50′ initially in its position of FIGS. 16 and 17 in which it functions as a bearing in the emergency situation and release it again only after the handle has been actuated a second time.

FIGS. 18a-18e explain an exemplary embodiment 101 of the second variant of the device mentioned above in schematic fashion, where the same reference numbers as those of FIG. 1 are used to designate the corresponding components. The associated description also applies. The structural unit 100 can be seen again, consisting of a transfer element 93 and a door handle 20. A door lock 102 and a chain of connecting links 96 for the handle are also shown.

The door lock 102 is installed in the door (not shown) of a vehicle. When the door is closed, the door lock 102 interacts with an element permanently attached to the frame of the door, which, in the present case, consists of a locking bolt 103. When the door is closed, the locking bolt 103 engages in a locking opening 104 and is gripped there by a catch hook 105. In the door lock 102 there is a detent pawl 107, which, when the door is closed, grips positively behind the catch hook 105 and secures it in its locking position. When the detent pawl 107 is pivoted, it releases the catch hook 105, and the door lock 102 is opened.

An actuator 108 is assigned to the door lock 102; this actuator can be driven electrically, electromagnetically, or pneumatically. The actuator 108 is activated by the remote control unit 109 shown in FIG. 18a and is a component of the central locking system of the vehicle.

The link chain 96 for the handle is in certain cases connected at 10.6 to the detent pawl 107, for which reason actuations of the handle 20 can open the door lock 102 if it is already in the previously mentioned released position. For this purpose, the handle's link chain 96 is provided with a driver 112. The device 101 can be provided not only with the handle 10 on the outside surface of the door but also with an inside handle (not shown) on the inside surface of the door, and it can also be equipped with an inside locking button.

The lock cylinder 95 works together with the link chain 96, i.e., with the handle 20 attached to this chain, as will be explained in greater detail below. The entire unit 100 is combined with the lock cylinder 95 into a module, which can be preassembled and then mounted as a unit on the door. The device 101 operates in the following way:

In the interior of the door lock 102, the actuator 108 acts on the coupling 106 between the previously mentioned driver 112 and the detent pawl 107. When the remote control unit 109 activates the actuator 108, this coupling 106 can be deactivated in the securing position of the door lock and activated in the released position. For this purpose the actuator 108 has a pin 117, which can move in and out, and which works together with a pivoting lever 118 in the door lock 102, at the end of which lever the above-cited driver 112 is located. This lever 108 is a component of the link chain 96 of the handle, to which it is connected by a joint indicated in the figures.

In the release position of FIG. 18a, this pin 117 is in its retracted position, as a result of which the driver 112 extends across the detent pawl 107. This retracted position of the pin 117 is symbolized in FIG. 18a by an arrow 113. In FIG. 18a, the door lock 102 is closed, and the detent pawl 107 is latched on the catch hook 105. The handle 20 is “unactuated” and is in its home position, indicated by the auxiliary line 20.1 in FIG. 18a. The coupling 106 between the driver 112 and the detent pawl 107 is operational.

In FIG. 18b, the handle has been actuated in the direction of the arrow 26 and is in its actuating position marked by the auxiliary line 20.2. The previously mentioned first stroke 119 has therefore been executed by the handle link chain 96 and transmitted via the driver 112 to the detent pawl 107. The detent pawl 107 has released the catch hook 105. Because of its spring loading, the catch hook has moved into the release position shown in FIG. 18b, in which the locking bolt 103 is no longer being gripped from behind. The door can be opened, which means that the locking bolt 103 can travel out of the opening 104 in the lock.

The actuating path 26 in this device 101 is limited by the lock cylinder 95, which remains in its first rotational position. In the present case, a withdrawable bolt 110 on the lock cylinder 95 is used for this purpose. The bolt functions as a stop for the handle 20. In the rotational position of the lock cylinder 95 of FIG. 18b, the bolt 20 is extended, which is illustrated there by the arrow 111. Preferably this stop action acts on the handle link chain 96, where the lever 118 and link chain 96 together form the transfer element 93 of the structural unit 100.

FIG. 18c shows the operating case in which the handle 20 is again in its home position 20.1 as in FIG. 18a; however, in this case the door lock 102 is in its securing position. The securing position is initiated by the actuation of the remote-control unit 109 and has the result that the pin 117 of the actuator 108 extends outward to the position shown in FIG. 18c, which is illustrated there by the arrow 114. The lever 118 is thus pivoted far enough that the driver 112 can no longer grip the detent pawl 107. The coupling 106 is rendered inactive. Because the lock cylinder 95 has the same rotational position as it does in the cases illustrated in FIGS. 18a and 18b, the handle 20 is again able to move by only a limited actuating distance 26, which, according to FIG. 18d, again allows only the short, first working stroke 119 of the handle link chain 96. In this case, the driver 112 moves through empty space. The detent pawl 107 remains in engagement with the catch hook 105. The lock 102 remains closed.

When in this device 101 the door lock 102 is to be opened in an emergency situation without the use of the remote-control unit 109, this can be done with the help of the lock cylinder 95, as explained in greater detail on the basis of FIG. 18e. When the inserted key 94 moves the lock cylinder 95 into its other rotational position, the bolt 110 travels inward, which is illustrated by the inward-travel arrow 116. The stop for the handle 20, i.e., for the transfer element 93 attached to it or the handle link chain 96, is thus deactivated. Now the handle 20 can be moved from its home position 20.1 over the longer distance 26′ of FIG. 18e to a second actuating position 20.3. This has the result that now the previously mentioned long working stroke 115 is possible. This working stroke 115 is composed, as FIG. 18e shows, of the small working stroke 119 and an additional stroke 120. Now an additional driver 121 provided on the lever 118 becomes operational. The door lock 102 is still in its securing position, because the actuator 108 remains in the same position as that shown in FIGS. 18c and 18d; the detent pawl 107, however, is carried along by the additional driver 121 as the long working stroke 115 is executed. The catch hook 105 releases the bolt 103. The door can be opened.

The handle link chain 96 is designed in FIGS. 18a-18d as a rod, but it could also be in the form of a Bowden cable as in the device 01 according to FIGS. 3-13 or as in the device 02 according to FIGS. 14-17.

FIGS. 19a and 19b show a third exemplary embodiment 03 of the first variant of the device based on the devices 01 and 02, which were explained in connection with FIGS. 3-17. In FIGS. 19a and 19b, only the structural unit 100 consisting of the handle 20 and a transfer element 93 comprising several levers is illustrated. The same reference numbers as in the preceding exemplary embodiments 01, 02 are used to designate analogous components.

The handle 20 is supported at one end of a bracket 13 on a pivot axis 122 essentially perpendicular to the plane of the drawing. At the other end of the handle, a driver 123 is seated, which is connected to a knee-shaped reversing lever 124 both with the freedom to rotate and with the freedom to slide. The reversing lever 124 is also supported pivotably on the bracket 13 on an axis 125 essentially perpendicular to the plane of the drawing. The end of the reversing lever 124 facing away from the driver 123 is connected to a tension cable 126 of a Bowden cable 127, which connects the structural unit 100 to a door lock (not shown). The end 128 of the tension cable 126 facing the structural unit 100 is flexibly connected to the reversing lever 124. The end 131 of the thrust sleeve 129 of the Bowden cable 127 facing the handle 20 is supported on an abutment 130, which is designed as a pivoting lever. The pivot axis 132 of this pivoting abutment 130 is also essentially perpendicular to the plane of the drawing.

On the bracket 13 there is, finally, a stationary stop 133, against which, in certain cases, the pivoting abutment 130, i.e., the end 131 of the thrust sleeve, is supported. At the output of the lock cylinder 60, a crank-like cam 134 is seated, which, when the key is actuated, pivots between one rotational position and another, these positions being approximately 180° apart. The two rotational positions can be seen in FIGS. 19a and 19b. The cam 134 drives the movable abutment 130 by way of a connecting rod 135. This device 103 works in the following way.

The transfer element 93 of the structural unit 100 in FIGS. 19a and 19b comprises the driver 123 and the reversing lever 124, which act by way of the Bowden cable 127 on the door lock (not shown). When the handle 20 is actuated, it pivots around its axis 122 over an angular distance limited by end stops. Then, by way of the driver 123, the reversing lever 124 also pivots around its axis 125, which exerts an effect on the tension cable 126 of the Bowden cable 127. Whether this produces a short working stroke 119 or a long working stroke 115 depends on the rotational position of the lock cylinder 60.

When the lock cylinder 60 is in the first rotational position shown in FIG. 19a, the connecting rod 135 ensures that the pivoting abutment 38 and the end 131 of the thrust sleeve rest against the stationary stop 133. The lock cylinder 60 is thus relieved of load, because actuations of the handle 20 cannot be transmitted to the lock cylinder 60. A relatively small gap 136 is produced between the abutment 133 and the end 128 of the cable. This has the effect of producing the short working stroke 119 of the tension cable 126 of the Bowden cable 127.

When the lock cylinder 60 occupies the other rotational position shown in FIG. 19b, however, the result is a displacement of the connecting rod 135 as illustrated by the double arrow 137. Along with the rod, the abutment 130 is moved by the same distance 137. The end 131 of the thrust sleeve 129 of the Bowden cable 127 is carried along as well. Relative to the starting position 128.1 of the end of the cable indicated in dash-dot line in FIG. 19b, there is a now a large gap 138 with respect to the pivoted abutment 130. This large gap 138 results from the sum of the previously described small gap 136 and the previously mentioned displacement 137. As a result, when the handle 20 is actuated as shown in solid line in FIG. 19b, the Bowden cable 127 executes the long working stroke 115. The arm of the reversing lever 124 connected to the cable end 128 arrives in the position shown in solid line, which characterizes the end position 128.2, shown in dash-dot line.

So that the door lock will not be opened unintentionally when the lock cylinder 60 is actuated in a phase between FIG. 19a and FIG. 19b, this additional stroke 137 is smaller than the short stroke 119 associated with the other rotational position of the lock cylinder 60.

### List of Reference Numbers

01 first exemplary embodiment of the first variant of the device (FIGS. 3-13)

02 second exemplary embodiment of the first variant of the device (FIGS. 14-17)

03 third exemplary embodiment of the first variant of the device (FIGS. 19a, 19b)

10 door

11 stationary open bearing seat for 31 in 14, first bearing point

12 movable open bearing seat in 50 for 32, second bearing point

12′ movable closed bearing seat in 50′ for 32, bearing bore of 50′

13 bracket

14 bearing cover at 11, 15 (FIG. 4)

15 longitudinal slot in 14 (FIG. 6)

16 restoring force of 40 for 34 (FIGS. 6, 8)

17 restoring force of 25 (FIG. 5)

18 bearing base of 11 for 31 (FIG. 6)

19 bearing cap for 14 (FIGS. 4, 6)

20 handle, pull handle (FIGS. 3-5)

20.1 home position of 20 (FIG. 5)

20.2 actuating position of 20 (FIG. 5)

20.3 second actuating position of 20 (FIG. 18e)

21 pivot bearing of 20 (FIG. 3)

21′ pivot axis of 20 (FIG. 14)

22 end of handle 20 (FIG. 5)

23 driven first arm of 25

24 driving second arm of 25 (FIG. 5)

25 reversing lever

26 actuation of 20 (FIG. 5), short actuating distance (FIGS. 18b, 18d)

26′ actuation over a long actuating distance (FIG. 18e)

26″ return movement of 20 (FIG. 7)

27 “sidepiece” type spring on 25 for 17 (FIG. 4)

28 contact point of 24 on 33 (FIG. 6)

29 opposing surface 29, second bearing point (FIG. 6)

30 transfer lever

30.1 starting position of 30 at 20.1 (FIG. 6)

30.2 actuating position of 30 (FIGS. 7, 6)

30.3 intermediate position of 30 during forward movement in the emergency situation (FIG. 10)

30.4 intermediate position during the return movement in the emergency situation (FIG. 12)

31 first bearing journal, first bearing point

32 second bearing journal, second bearing point

33 first arm of 30, input arm

33.1 arm length of 33 in the normal case (FIG. 6)

33.2 arm length of 33 in the emergency situation (FIG. 9)

34 second arm of 30, output arm

34.1 arm length of 31 in the normal case (FIG. 6)

34.2 arm length of 34 in the emergency situation (FIG. 9)

35 connecting point for 40, pivot joint in 34 (FIG. 6)

35.0 home position of 35 (FIGS. 6, 14)

35.1 actuating position of 35 in the normal case (FIGS. 7, 15)

35.2 intermediate position of 35 during forward movement in the emergency situation (FIG. 10)

35.3 final position of 35 in the emergency situation (FIG. 11)

35.4 intermediate position of 35 during the return movement in the emergency situation (FIG. 12)

36 arrows of the working stroke in the normal case (FIGS. 6, 7)

36′ arrow of the return stroke of 35 in the normal and emergency situations (FIGS. 8, 13)

37 cam on 33 (FIG. 9)

38 drive distance of 28 between 33.1 and 33.2 (FIGS. 6 and 9)

39 spring between 50 and 65 (FIGS. 4 and 6)

40 connection, core of 41

41 Bowden cable

42 sleeve of 41

43 extension of 13 (FIG. 4)

44 pivot bearing for 45 on 13 (FIG. 6)

45 driver, angle lever (FIGS. 3-13)

45′ driver, thrust element (FIGS. 14-17)

45.0 null position of 45 (FIGS. 6 and 9)

45.1 pivoted position of 45 (FIG. 9)

46 first angle arm of 45, drive arm (FIG. 6)

47 second angle arm of 45, takeoff arm (FIG. 6)

48 fork of 47, link guide (FIG. 6)

49 free movement of 32 in 15, pivoting movement distance (FIG. 7)

50 control element, slider (FIGS. 6-13)

50′ control element, pivoting part (FIGS. 14-17)

50.1 inactive position of 50

50.2 active position of 50

51 rotation of 31 in 11 (FIGS. 6, 14)

52 rotation of 32 in 12 and 29 (FIGS. 9, 16)

53 distance by which 50 is pushed between 50.1 and 50.2 (FIG. 9)

54 guide surface on 13 for 66, 50 (FIGS. 6, 9)

55 stationary shoulder for 66 (FIG. 9)

56 free movement of 31 in 11, pivot arrow (FIG. 10)

57 restoring force of 45 on 50 (FIG. 11)

58 pin on 50, link guide (FIG. 6)

59 arrow of the return movement of 50, 65 from 50.2 to 50.1 (FIG. 11)

60 lock cylinder in 13

60.1 null position of 60 (FIG. 6)

60.2 release position of 60 (FIG. 10)

61 cylindrical bolt on 60

62 spring with dual function

63 key-actuated rotation of 60 (FIGS. 9, 16)

63′ reverse rotation of 60 (FIG. 10)

64 arrow of the pivoting movement of 45 (FIG. 9)

65 catch with 66 (FIG. 6)

66 latching element, latching prong on 65 (FIG. 9)

67 arrow of the force on 60 toward 60.1 (FIG. 9)

68 control surface on 65 for 37 (FIG. 10)

69 actuating travel of 20 between 20.1 and 20.2 (FIG. 5)

70 working stroke of 35 in the emergency case (FIGS. 9, 17)

71 initial travel of 35 for 70 (FIG. 10)

72 final travel of 35 for 70 (FIG. 11)

73 initial travel of the return movement of 35 (FIG. 12)

74 force arrow of 39 on 65 (FIGS. 6, 9)

75 torque-exerting effect of 65 because of 74 (FIGS. 9, 10)

76 arrow of the movement of 66 when engaging (FIG. 9)

77 arrow of the release movement of 66 (FIG. 11)

78 stationary guide for 45′ (FIG. 14)

79 longitudinal displacement arrow of 45′ (FIG. 16)

80 guide segment for 50′ (FIG. 16)

81 stop for 50′ (FIG. 16)

82 connecting rod between 50′ and 45′ (FIG. 16)

83 hinge point between 82 and 45′ (FIG. 14)

84 hinge point between 82 and 50′ (FIG. 14)

85 angle profile of 81 (FIG. 14)

86 contact lobe of 50′ (FIG. 14)

87 gap between 86 and 81 (FIG. 14)

88 opening in 45′ (FIG. 14)

89 arrow of the lifting-away movement of 50′ from 80 (FIG. 15)

90 rotation of 50′ (FIG. 16)

91 bearing shell for 11 (FIG. 14)

92 lever axis for 25 (FIG. 14)

93 transfer element

94 key for 95

95 lock cylinder

96 handle link chain

97 output of 95

98 action line between 97 and 93 (FIG. 1)

99 alternative action line between 97 and 20 (FIG. 1)

100 structural unit consisting of 20 and 93

101 exemplary embodiment of the second variant of the device (FIGS. 18a-18e)

102 door lock (FIGS. 18a-18e)

103 locking bolt for 105 (FIGS. 18a-18e)

104 lock opening for 105 (FIGS. 18a-18e)

105 catch hook for 103 (FIG. 18a)

106 coupling between 18 and 96 (FIGS. 18a-18e)

107 detent pawl for 105 (FIGS. 18a-18e)

108 actuator in 102 (FIGS. 18a-18e)

109 remote-control unit for 108 (FIGS. 18a-18e)

110 bolt in 95, stop (FIG. 18b)

111 arrow of the outward travel of 110 (FIG. 18b)

112 driver on 118 or 96 (FIG. 18a)

113 arrow of the inward travel of 117 (FIGS. 18a, 18b)

114 arrow of the outward travel of 117 (FIGS. 18c, 18d)

115 second, long working stroke of 96 (FIGS. 1, 2c, 18e)

116 arrow of the inward travel of 110 (FIG. 18e)

117 pin on 108 (FIGS. 18a-18e)

118 pivoting lever on 96 (FIGS. 18a-18e)

119 first, short working stroke of 96 (FIGS. 1, 2b, 18b, 18d)

120 additional stroke added to 119 for 115 (FIG. 18e)

121 additional driver on 18 (FIG. 18e)

122 pivot axis of 20 on 13 (FIG. 19a)

123 driver on 20 (FIG. 19a)

124 knee-shaped reversing lever (FIG. 19a)

125 pivot axis of 124 on 13 (FIG. 19a)

126 tension cable of 127 (FIGS. 19a, 19b)

127 Bowden cable (FIGS. 19a, 19b)

128 cable end of 126 (FIGS. 19a, 19b)

128.1 starting position of 128 (FIG. 19a)

128.2 ending position of 128 (FIG. 19b)

129 thrust sleeve of 127 (FIG. 19a)

130 pivoting abutment

131 support end of 129

132 pivot axis of 130

133 stationary stop for 130 on 13 (FIG. 19a)

134 cam on 60 for 135

135 connecting rod on 134

136 short distance between 133, 128.1 (FIG. 19a)

137 double arrow of the displacement of 135 (FIGS. 19a, 19b)

138 long distance between 133 and 128.1 (FIG. 19b)

1. Device for actuating a lock on doors, flaps, etc., especially on vehicles,
with a stationary handle (20) supported on the door, which handle executes a pivoting movement when manually actuated (26, 26′);
wherein a transfer element (93) is provided downline from the handle (20), the transfer element (93) and the handle (20) form a single structural unit (100); and
wherein a handle link chain (96) is attached to the transfer element (93), which chain transmits the pivoting movement of the handle (20) to a door lock (102) in the form of a working stroke (115; 119), the length of which is determined by the transmission ratio of the transfer element (93);
with a lock cylinder (95) mounted permanently on the door, which cylinder can be rotated by means of a key (94) from one position to at least one other position and which acts by way of an output (97) on the door lock (102); and
wherein, in one of the two rotational positions of the lock cylinder (95), the door lock (102) is in a securing position, in which the actuation (26) of the handle is without effect, whereas, in the other position, the door lock is in a release position, in which the actuation (26, 26′) of the handle opens the door lock (102),
characterized in that
only a single link chain (95) for the handle is present between the structural unit (100) and the lock cylinder (95) and between said unit and the door lock (102); in that
the output (97) of the lock cylinder (95) acts on the structural unit (100) formed by the handle (20) and the transfer element (93) to change the working stroke (119; 115) of the link chain (96) as a function of the rotational position of the lock cylinder (95); and in that
the door lock (102) responds to these different working strokes (119; 115) of the link chain (96) and initiates different functions accordingly.

2. Device according to claim 1, characterized in that the output (97; 61) of the lock cylinder (95; 60) is connected to the transfer element (93; 30) of the structural unit (100), the transmission ratio (34.1 to 33.1 or 34.2 to 33.2) of the transfer element (95; 30) being changed as a function of these rotational positions (60.1, 60.2); and in that
the handle (20), when actuated (26), always executes the same pivoting movement, but the working stroke (119, 115 or 36, 70) of the handle link chain (96; 40) varies as a function of the transmission ratio (34.1 to 33.1 or 34.2 to 33.2) of the transfer element (95; 30).

3. Device according to claim 1, characterized in that the output (97; 110) of the lock cylinder (95) works together with the handle (20) of the structural unit (100) to change the angle of the pivoting movement (26, 26′) of the handle (20) as a function of the rotational position of the lock cylinder (95); and in that
the handle link chain (96) executes different working strokes (119; 115) as a function of the variable angle of the pivoting movement (26, 26′) of the handle.

4. Device according to claim 2, characterized in that the transfer element consists of a lever (transfer lever 30), the bearing point (31, 11; 32, 12) of which is variable in its location; and in that
the position of the bearing point of the transfer lever (30) changes as a function of the rotational position (60.1, 60.2) of the lock cylinder (60).

5. Device according to claim 4, characterized in that the rotation of the lock cylinder (60) acts by way of a control element (50; 50′) on the bearing points (31, 11; 32, 12) of the transfer lever (30).

6. Device according to claim 4 or claim 5, characterized in that a small (34.1/33.1) transmission ratio is present when the lock cylinder is in the null position (60.1), whereas a large transmission ratio (34.2/33.2) is present when the cylinder is in the key-actuated position (60.2).

7. Device according to one of claims 4-6, characterized in that the transfer lever (30) has two bearing points (31, 11; 32, 12), and in that
the control element (50, 50′) activates one of the two bearing points (31, 11; 32, 12) and deactivates the other.

8. Device according to claim 7, characterized in that the transfer lever (30) has two bearing journals (31, 32) a certain distance apart, which are different arm lengths (30.1, 34.1; 33.2, 34.2) away from the contact point (28) with the handle (20) on the one side and from the connection (40) to the lock on the other; and in that
a bearing seat (11, 12) is assigned to each of the two bearing journals (31, 32), one of these seats (11) being stationary on the bracket (13), while the other (12) is on the movable control element (50).

9. Device according to claim 7 or claim 8, characterized in that one of the two bearing journals (31) is rotatably supported nonpositively in the open bearing seat (11) assigned to it by an elastic force (16); and in that
this elastic force (16) is produced by restoring forces, which are exerted by the handle (20) and/or by the connection (40) to the lock or by the intermediate elements downstream from the connection.

10. Device according to one of claims 4-9, characterized in that the two bearing seats (11, 12) are open; and
in the null position (60.1) of the lock cylinder (60) the control element (50) is in an inactive position (50.1),
where its bearing seat (12) is a certain distance away from its assigned bearing journal (32), thus allowing this bearing journal (32) a certain freedom of movement (49) when the handle is actuated (26) and the actuating lever (30) thus pivots around the other bearing journal (31), which is supported in the stationary bearing seat (11); and in that
in the release position (60.2) of the lock cylinder (60), the control element (50) is in an active position (50.2),
where its bearing seat (12) receives the bearing journal (32) assigned to it, pushing the journal positively against a stationary opposing surface (29)-, whereas the other bearing journal (31), upon actuation (26) of the handle, moves freely away (56) from its bearing point (11) in the open bearing seat

11. Device according to one of claims 4-10, characterized in that an angle lever (43) acts on the output (61) of the lock cylinder (60), this lever being pivotably supported (44) eccentrically with respect to the axis of the cylinder; and in that
the lock cylinder (60) has an eccentric cylinder bolt (61), which acts on one of the angle arms (drive arm 46) of the lever, whereas the control element (50) is connected by a link (48, 58) to the other angle arm (takeoff arm 47) of the angle lever (45).

12. Device according to one of claims 4-11, characterized in that a restoring spring (62) acts on the output element (45), which spring acts simultaneously as an impulse spring on the lock cylinder (60), trying to push (76) the lock cylinder (60) into its null position (60.1).

13. Device according to one of claims 4-12, characterized in that the control element consists of a slider (50), at one end of which the bearing seat (12) for the second bearing journal (32) of the transfer lever (30) is located, whereas the other end of the slider engages by way of a pin (58) in a slot or fork-like opening (48) in the angle lever (45) of the lock cylinder (60); and in that
the bracket (13) has guides (54) for the control element (50), in which the control element (50) can be slid by the angle lever (45) between its active and inactive positions (50.2; 50.1).

14. Device according to one of claims 4-13, characterized in that the control element (50) is provided with a latching element (66), which grips behind a stationary shoulder (55) on the bracket (13) when the control element (50) is in its active position (50.2) to secure the control element in its active position (50.2); and in that
the latching element (66) is released again from the latching position by a cam (37), which moves concomitantly with the actuation (26) of the handle, the control element (50) thus being returned (59) to its inactive position (50.1) by a restoring force (57).

15. Device according to claim 14, characterized in that the cam (37) is made as an integral part of the transfer lever (30).

16. Device according to one of claims 13-15, characterized in that the latching element (66) consists of a spring-loaded latching prong on a catch (65), which moves concomitantly with the slider (50); and in that
the catch (65) is elastically supported on the slider (50).

17. Device according to claim 16, characterized in that the catch (65) is pivotably supported on the pin (58) of the control element (50) which serves to guide the link (58, 48) between the control element (50) and the angle lever (45) of the lock cylinder (60).

18. Device according to one of claims 4-9, characterized in that, at the output (61) of the lock cylinder (60), a thrust element (45′) is connected, which can slide longitudinally (79) in a stationary guide (78) mounted next to the lock cylinder (60); and in that
the lock cylinder (60) has an eccentric cylinder bolt (61), which engages in an opening (88) in the thrust element (45′) and thus carries the thrust element (45′) along when the lock cylinder (60) rotates (63).

19. Device according to claim 18, characterized in that the control element consists of a pivoting part (50′) and is pivotably supported on the transfer lever (30).

20. Device according to claim 19, characterized in that the pivoting part (50′) is pivotably supported on the second bearing journal (32) seated on the transfer lever (30), forming a closed bearing seat (12′) for this second bearing journal (32); in that
the pivoting part (50′) is hinged to the thrust element (45′); and in that
a stationary guide segment (80) is assigned to one side of the pivoting part (50′), and a stationary stop (81) is assigned to the other side.

21. Device according to claim 19 or claim 20, characterized in that the stop (81) has an angle profile (85), and the pivoting part (50′) has a contact lobe (86),
which is supported on the angle profile (85) when the lock cylinder (60) in the release position (60.2′).

22. Device according to one of claims 19-21, characterized in that, when the lock cylinder (60′) is in the null position (60.1′), the contact lobe (86) of the pivoting part (50′) is rotated away from the angle profile (85) and occupies a position a certain distance (87) away from the stop (81); and in that
when the handle is actuated, the pivoting part (50′) seated on the second bearing journal (32) moves freely along with the actuating lever (30) without interference from the stop (81).

23. Device according to one of claims 19-22, characterized in that a connecting rod (84) is installed between the pivoting part (50′) and the thrust element (45′) and has hinge points (83, 84) at both ends.

24. Device according to one of claims 1-23, characterized in that the link chain (95; 40) of the handle is a Bowden cable (127; 41) with a thrust sleeve (129; 42) and a tension cable (126; 40), where the handle (20) acts directly or indirectly on the tension cable (126).

25. Device according to claim 24, characterized in that the end (131) of the thrust sleeve (129) facing toward the handle (20) is supported on a movable abutment (130); in that
the abutment (130) can be shifted between two end positions by the lock cylinder (60); in that
when the lock cylinder (60) is not being actuated, the abutment (130) occupies a first end position, in which the end (131) of the thrust sleeve is a first distance (136) away from the end (128) of the tension cable connected to the handle (20); and in that
when the lock cylinder (60) is being actuated, the abutment (130) occupies a second end position, in which the end (131) of the thrust sleeve is a second distance (138) away from the end (128) of the tension cable, where this second distance (138) is greater than the first distance (136).

26. Device according to claim 25, characterized in that a stationary stop (133) is provided, against which the thrust sleeve end (131) and/or the movable abutment (130) is supported in the first end position.

27. Device according to claim 25 or claim 26, characterized in that the lock cylinder (60) is connected by a connecting rod (135) to the movable abutment (130) in such a way that
a rotation of the lock cylinder (60) causes a longitudinal displacement of the connecting rod (135).

28. Device according to claim 3, characterized in that the lock cylinder (95) has an adjustable stop (110); in that
when the lock cylinder (95) is not being actuated, the stop (110) is active, thus limiting the actuating distance (26) of the handle (20), as a result of which, during the actuation (26) of the handle, only a first stroke (119) is transmitted to the handle link chain (96); and in that
when the lock cylinder (60) is being actuated, the stop (110) is inactive, as a result of which the handle (20) has a different actuating distance (26′), and a different, second stroke (115) is executed by the handle link chain (96).

29. Device according to claim 28, characterized in that the difference (120) between the first stroke (119) and the second stroke (115) is smaller than the first stroke (119).
